(19) United States
(12) Patent Application Publication
(10) Pub. No.: US 2025/0341792 A1
(43) Pub. Date: Nov. 6, 2025

(54) IMAGE FORMING APPARATUS

(71) Applicant: CANON KABUSHIKI KAISHA, Tokyo (JP)

(72) Inventors: Takanori Watanabe, Kanagawa (JP); Jun Hara, Kanagawa (JP); Akisato Sakaki, Kanagawa (JP); Hikaru Osada, Kanagawa (JP); Isamu Takeda, Tokyo (JP)

(21) Appl. No.: 19/186,733

(22) Filed: Apr. 23, 2025

(30) Foreign Application Priority Data
May 2, 2024 (JP) 2024-074990

(51) Int. Cl. G03G 15/01

(52) U.S. Cl. CPC G03G 15/0121; G03G 15/011; G03G 15/0173

(57) ABSTRACT

An image forming apparatus includes a main assembly including a photosensitive drum, a developing unit, and a rotary, and includes a toner cartridge. The toner cartridge includes a frame extending in a longitudinal direction and including an accommodating chamber, a first discharge opening through which the toner discharged from the accommodating chamber to the developing unit passes, and a second discharge opening through which the toner discharged from the accommodating chamber to the developing unit passes. The second discharge opening is provided in a position different in position from the first discharge opening with respect to the longitudinal direction, and a partitioning portion for partitioning the accommodating chamber into a plurality of spaces including a first space and a second space separated from the first space. The first discharge opening communicates with the first space. The second discharge opening communicates with the second space.

### FIELD OF THE INVENTION AND RELATED ART

The present invention relates to an image forming apparatus including a toner cartridge for accommodating toner.

In an image forming apparatus of an electrophotographic type, a rotary developing type in which a color image is formed by rotating a rotary provided with a plurality of developing members has been known. In Japanese Laid-Open Patent Applications No. 2008-096852, an image forming apparatus including a rotary provided with a plurality of developing rollers and a plurality of toner cartridges (toner accommodating containers) each detachably mountable to the rotary.

The toner accommodated in the toner cartridge is localized inside the toner cartridge in some cases depending on an attitude of the toner cartridge during transportation until the toner cartridge reaches a user's place or during storage.

### SUMMARY OF THE INVENTION

A principal object of the present invention is to provide an image forming apparatus capable of improving an operating property when a toner cartridge is exchanged.

According to an aspect of the present invention, there is provided an image forming apparatus comprising: a main assembly including a photosensitive drum, a developing unit including a developing roller, and a rotary rotatably supporting the developing unit; and a toner cartridge detachably mountable to the developing unit, the toner cartridge including a frame extending in a longitudinal direction and including an accommodating chamber for accommodating toner, a first discharge opening through with the toner discharged from the accommodating chamber to the developing unit passes, and a second discharge opening through which the toner discharged from the accommodating chamber to the developing unit passes, wherein the second discharge opening is provided in a position different in position from the first discharge opening with respect to the longitudinal direction, and a partitioning portion configured to partition the accommodating chamber into a plurality of spaces including a first space and a second space separated from the first space, wherein the first discharge opening communicates with the first space, and the second discharge opening communicates with the second space.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to an embodiment 1.

Parts (a) of FIG. 2 is a sectional view showing a state in which a rotary main body takes a development attitude, part (b) of FIG. 2 is a sectional view showing a state in which the rotary main body takes a separation attitude, part (c) of FIG. 2 is a sectional view showing a state in which the rotary main body takes a stand-by attitude, and part (d) of FIG. 2 is a sectional view showing a state in which the rotary main body takes an exchange attitude.

Part (a) of FIG. 3 is a sectional view showing a state in which a tray and a toner cartridge are accommodated in the rotary main body, and part (b) of FIG. 3 is a sectional view showing a state in which the tray and the toner cartridge are pulled out from the rotary main body.

Part (a) of FIG. 4 is a schematic view showing a developing (device) frame and the toner cartridge mounted to the developing frame, and part (b) of a schematic view showing a communicating direction of a communicating portion.

Part (a) of FIG. 5 is a schematic view showing an attitude in which toner supply of the toner cartridge is started, parts (b) to (d) of FIG. 5 are schematic views showing an attitude during the toner supply of the toner cartridge, and part (e) of FIG. 5 is a schematic view showing an attitude in which the toner supply of the toner cartridge is completed.

Part (a) of FIG. 6 is a sectional view showing a cross section perpendicular to a thickness direction of the toner cartridge, and part (b) of FIG. 6 is a sectional view perpendicular to a widthwise direction of the toner cartridge.

Part (a) of FIG. 7 is a sectional view showing the toner cartridge in a state in which a second frame is demounted, and part (b) of FIG. 7 is a sectional view showing a state in which the second frame is mounted to a first frame.

Part (a) of FIG. 8 is a sectional view showing a cross section of a toner cartridge perpendicular to a thickness direction of the toner cartridge in a comparison example 1, and part (b) of FIG. 8 is a sectional view showing a cross section of the toner cartridge perpendicular to a widthwise direction of the toner cartridge in the comparison example 1.

FIG. 9 is a perspective view showing an attitude of the toner cartridge during a tapping test.

Part (a) of FIG. 10 is a sectional view showing a state of toner after the tapping test in the embodiment 1, and part (b) of FIG. 10 is a sectional view showing a state of the toner after toner consumption.

Part (a) of FIG. 11 is a sectional view showing a state of toner after the tapping test in the comparison example 1, and part (b) of FIG. 11 is a sectional view showing a state of the toner after toner consumption.

Part (a) of FIG. 12 is a sectional view showing an inside structure of a toner cartridge in a modified embodiment 1 of the embodiment 1, and part (b) of FIG. 12 is a sectional view showing an inside structure of a toner cartridge in a modified embodiment 2 of the embodiment 1.

Part (a) of FIG. 13 is a sectional view showing a toner cartridge in an embodiment 2, and part (b) of FIG. 13 is a sectional view showing a positional relationship between the toner cartridge and a scanner.

Part (a) of FIG. 14 is a sectional view showing a toner cartridge in a comparison example 2, and part (b) of FIG. 13 is a sectional view showing a positional relationship between the toner cartridge and a scanner.

Part (a) of FIG. 15 is a sectional view showing a state of toner after a tapping test in the embodiment 2, and part (b) of FIG. 15 is a sectional view showing a state of toner after toner consumption.

Part (a) of FIG. 16 is a sectional view showing a state of toner after a

tapping test in the comparison example 2, and part (b) of FIG. 16 is a sectional view showing a state of toner after toner consumption.

Part (a) of FIG. 17 is a sectional view showing a cross section of a toner cartridge perpendicular to a thickness direction of the toner cartridge in an embodiment 3, and part (b) of FIG. 17 is a sectional view showing a cross section of the toner cartridge perpendicular to widthwise direction of the toner cartridge.

Part (a) of FIG. 18 is a sectional view showing a cross section of a toner cartridge perpendicular to a thickness direction of the toner cartridge in a comparison example 3, and part (b) of FIG. 18 is a sectional view showing a cross section of the toner cartridge perpendicular to a widthwise direction of the toner cartridge.

Part (a) of FIG. 19 is a sectional view showing the toner cartridge in a state in which a second frame is demounted, and part (b) of FIG. 19 is a sectional view showing a state in which the second frame is mounted to a first frame.

FIG. 20 is a schematic view showing the toner cartridge rotating about a rotational axis as viewed in Y direction.

Part (a) of FIG. 21 is a schematic view showing a cross section of the toner cartridge perpendicular to the Y direction of the toner cartridge in a position Tp3 in FIG. 20 and a cross section of the toner cartridge perpendicular to H direction, and part (b) of FIG. 21 is a schematic view showing a cross section of the toner cartridge perpendicular to the Y direction of the toner cartridge in a position Tp7 in FIG. 20 and a cross section of the toner perpendicular to H direction.

Part (a) of FIG. 22 is a sectional view showing a state of toner after a tapping test in the embodiment 3, and part (b) of FIG. 22 is a sectional view showing a state of the toner after toner consumption.

Part (a) of FIG. 23 is a sectional view showing a state of toner after a tapping test in the comparison example 3, and part (b) of FIG. 23 is a sectional view showing a state of the toner after toner consumption.

Part (a) of FIG. 24 is a sectional view showing a cross section of a toner cartridge perpendicular to a thickness direction of the toner cartridge in a modified embodiment of the embodiment 3, and part (b) of FIG. 24 is a sectional view showing a cross section of the toner cartridge perpendicular to the widthwise direction of the toner cartridge.

### DESCRIPTION OF THE EMBODIMENTS

In the following, embodiments of the present invention will be described with reference to the drawings.

### Embodiment 1

An image forming apparatus 1 according to an embodiment 1 will be described.

In the following description and respective drawings, a vertical direction in the case where the image forming apparatus 1 is installed on a horizontal surface is a Z direction. A direction (rotational axis direction of a rotary) of a rotational axis 90C of a rotary main body 90 described later, which is a direction crossing the Z direction is a Y direction. Incidentally, a direction of a rotational axis of a photosensitive drum 2 (photosensitive drum rotational axis direction) is also parallel to the direction of the rotational axis 90C of the rotary main body 90, and is the Y direction. A direction crossing both the Z direction and the Y direction is an X direction. The X direction and the Y direction may preferably be a horizontal direction. Further, the X direction, the Y direction, and the Z direction may preferably be perpendicular to each other. Further, as needed, directions of arrows X, Y, and Z indicated in the respective drawings are represented by +X side, +Y side, and +Z side, respectively, and opposite sides therefrom are represented by −X side, −Y side, and −Z side, respectively.

### (General Constitution of Image Forming Apparatus)

First, a general constitution of the image forming apparatus 1 will be described. The image forming apparatus 1 is a laser beam printer for forming an image on a sheet S by an electrophotographic system. Specifically, the image forming apparatus 1 is a color laser beam printer provided with four developing units 50y, 50m, 50c, and 50k. As the sheet S which is a recording material (recording medium), various sheet materials different in size and material, including paper such as plain paper and thick paper; a plastic film; a cloth; a surface-treated sheet material such as coated paper; a special-shaped sheet material such as an envelope and index paper; and the like are usable.

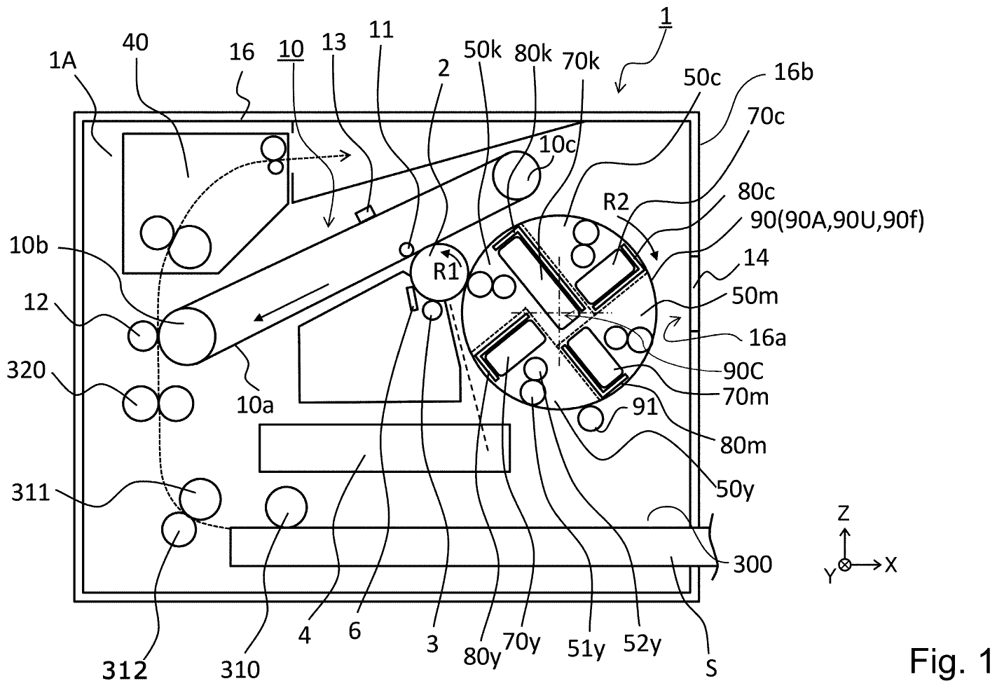

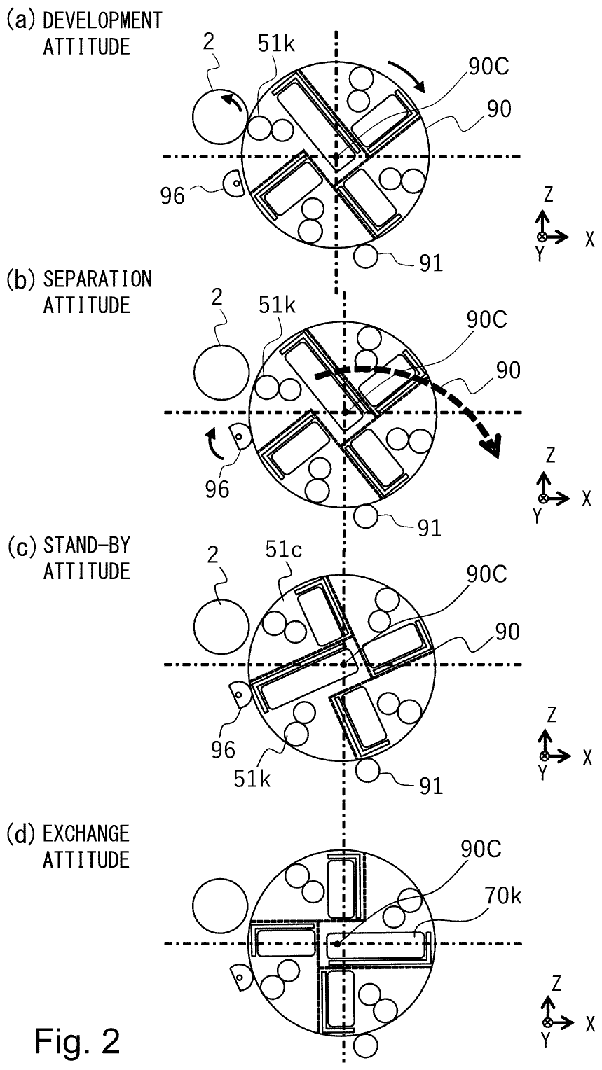

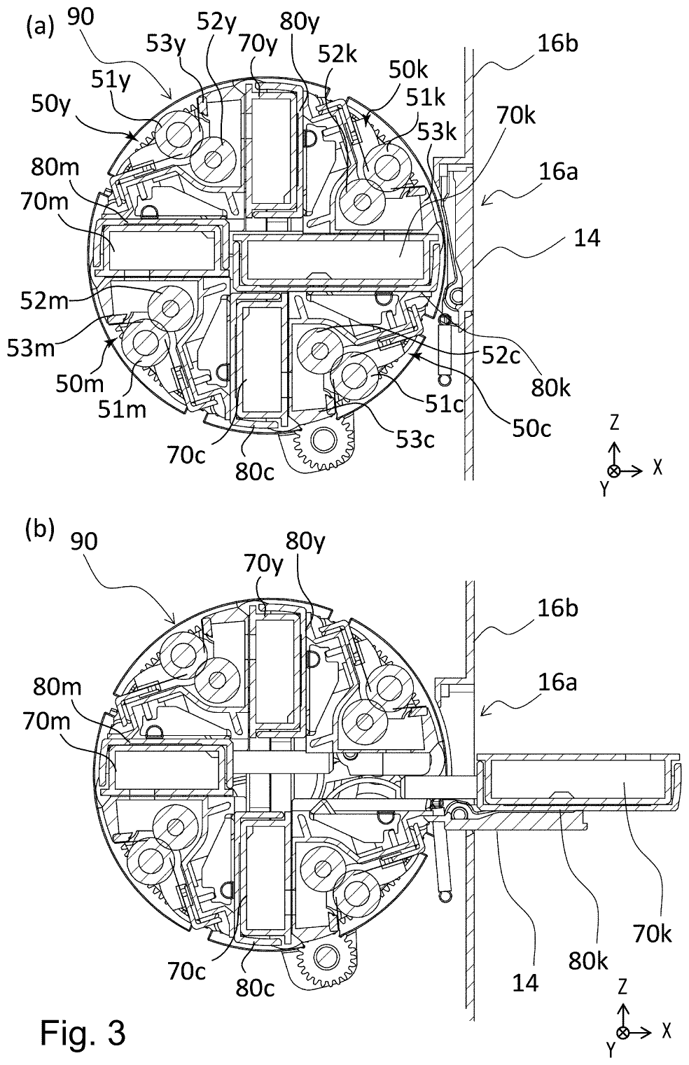

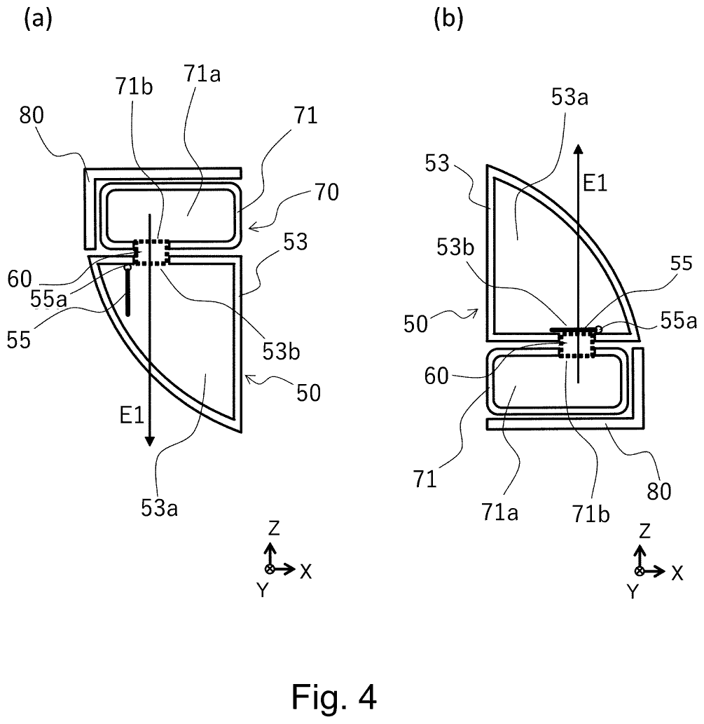

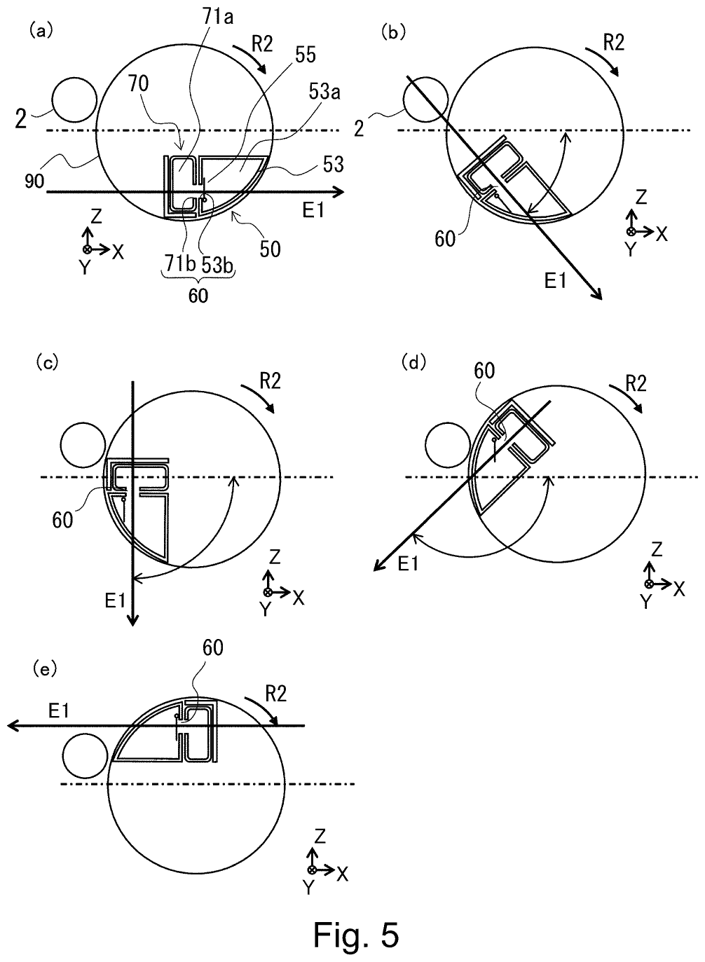

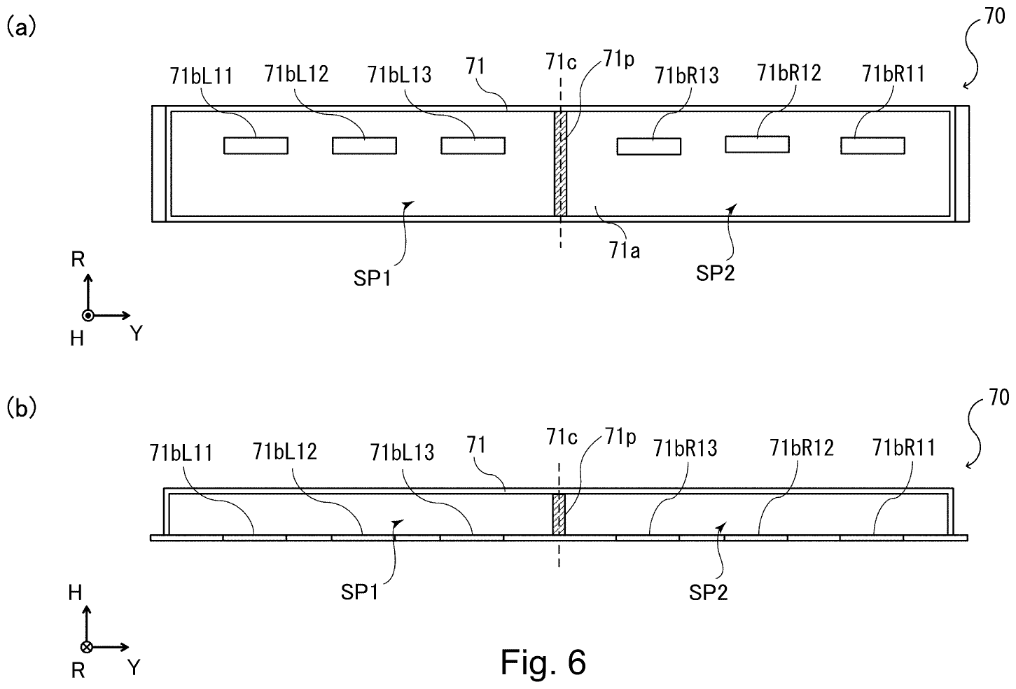

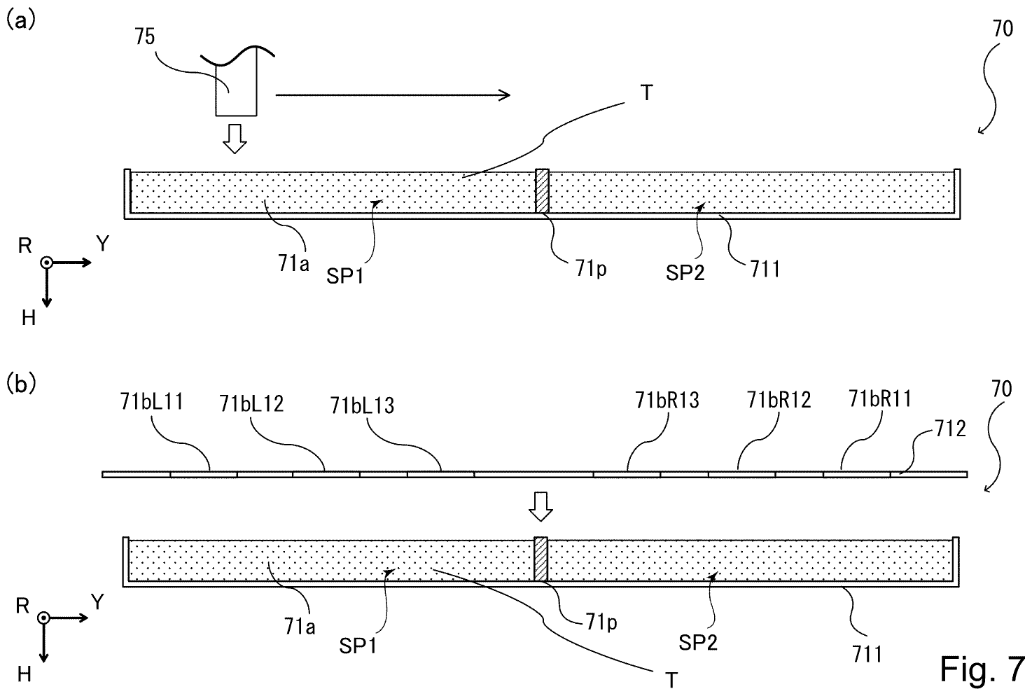

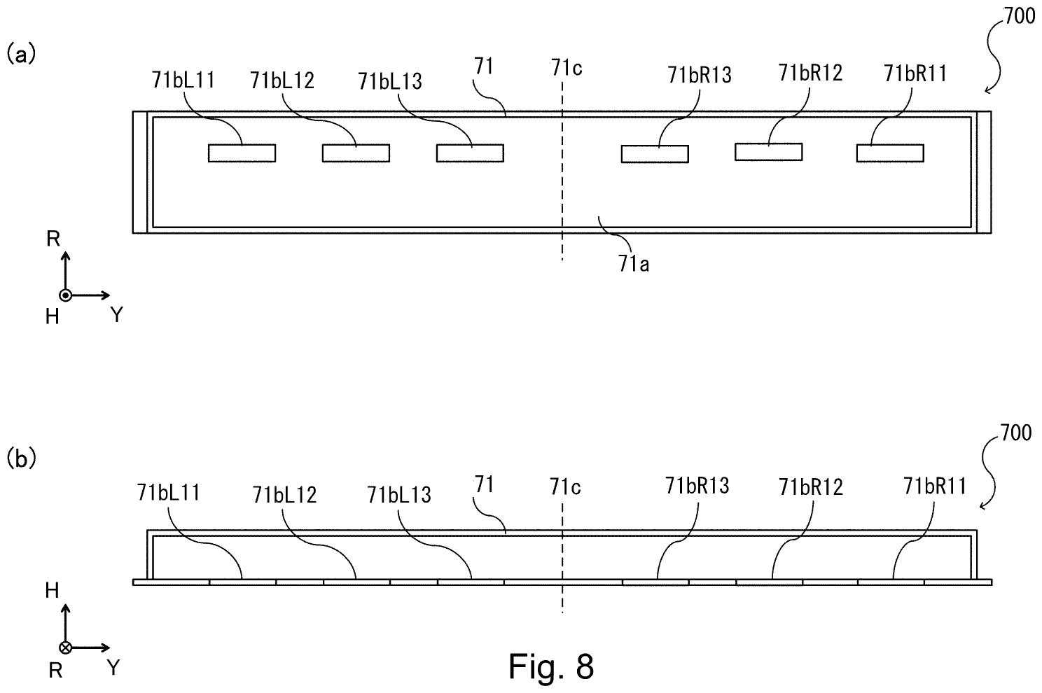

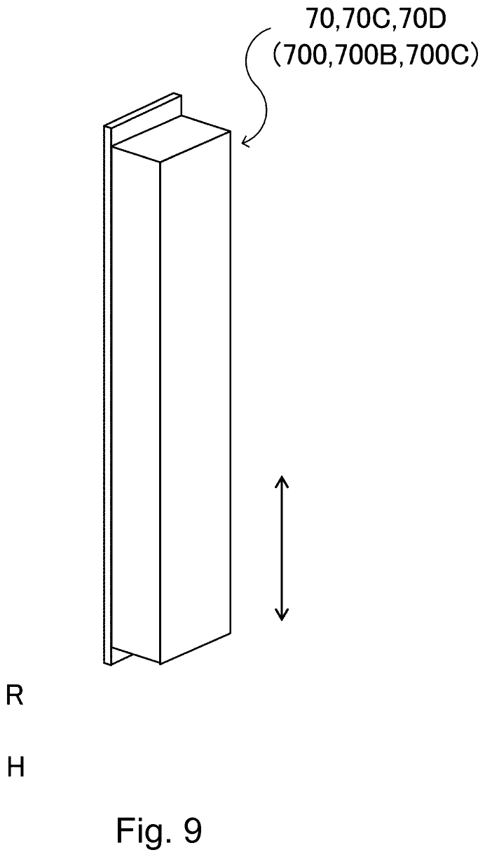

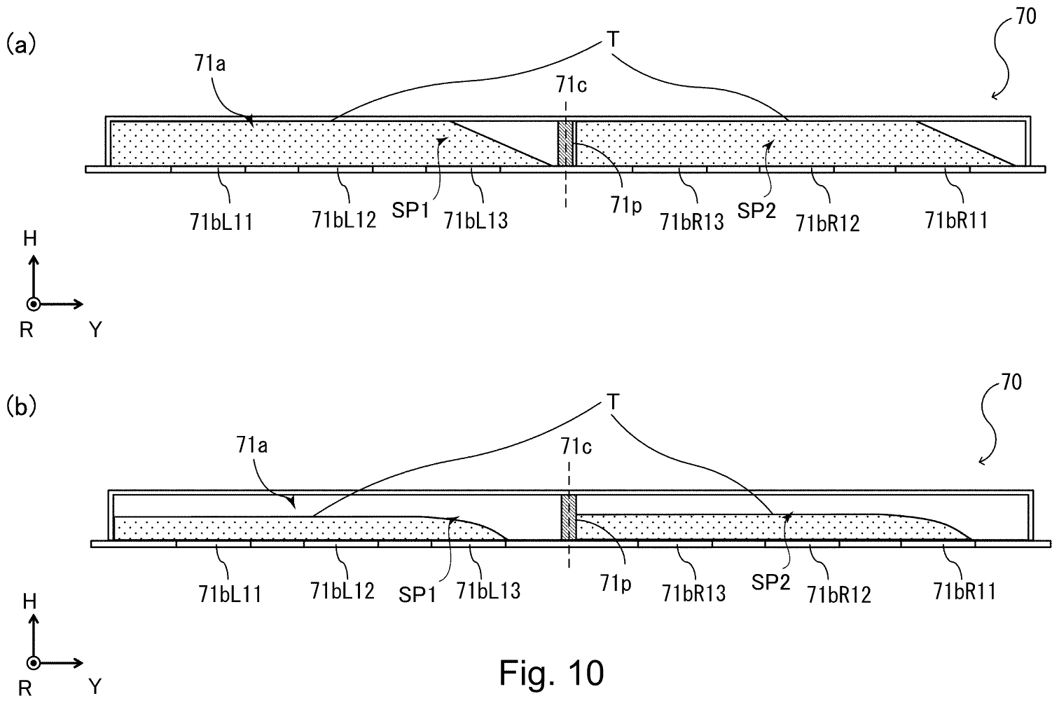

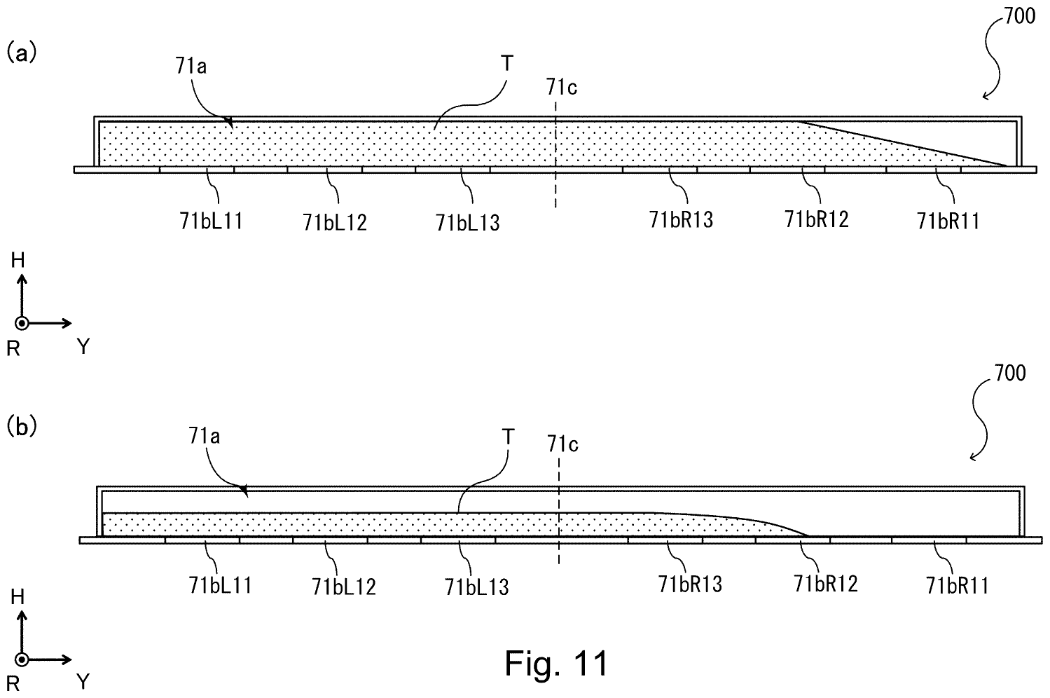

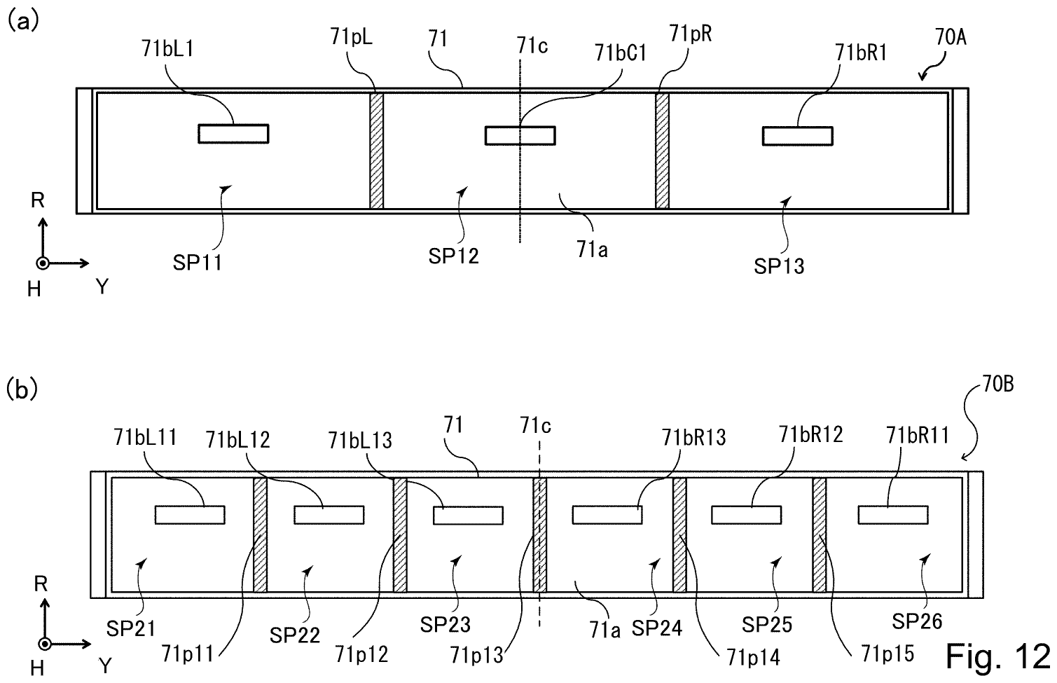

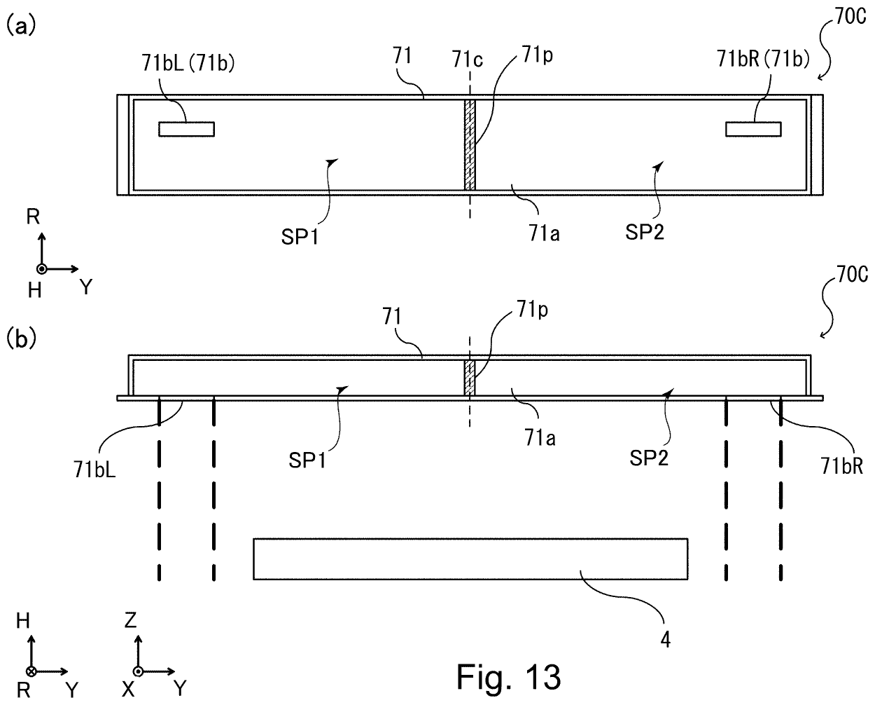

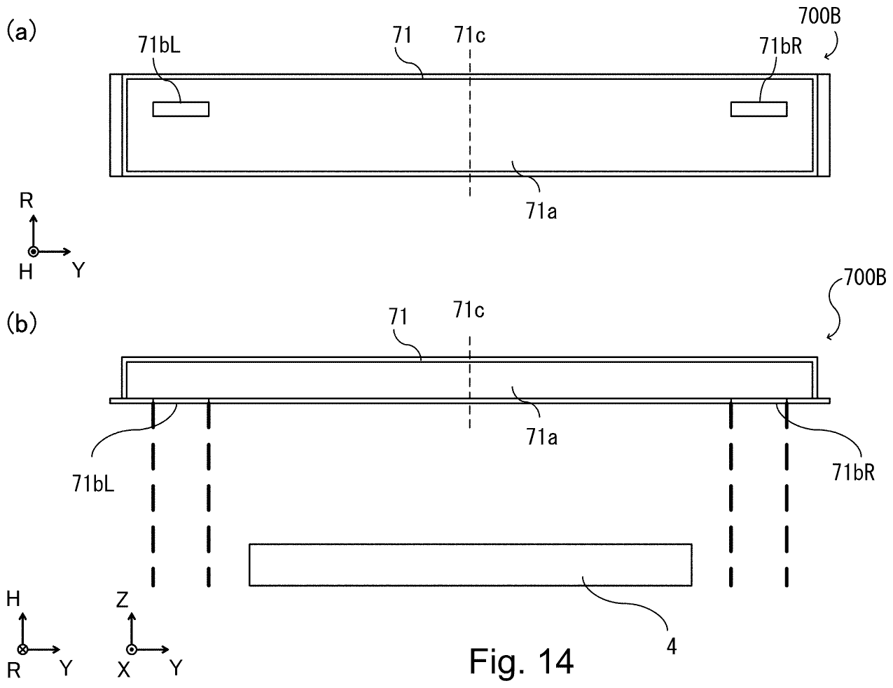

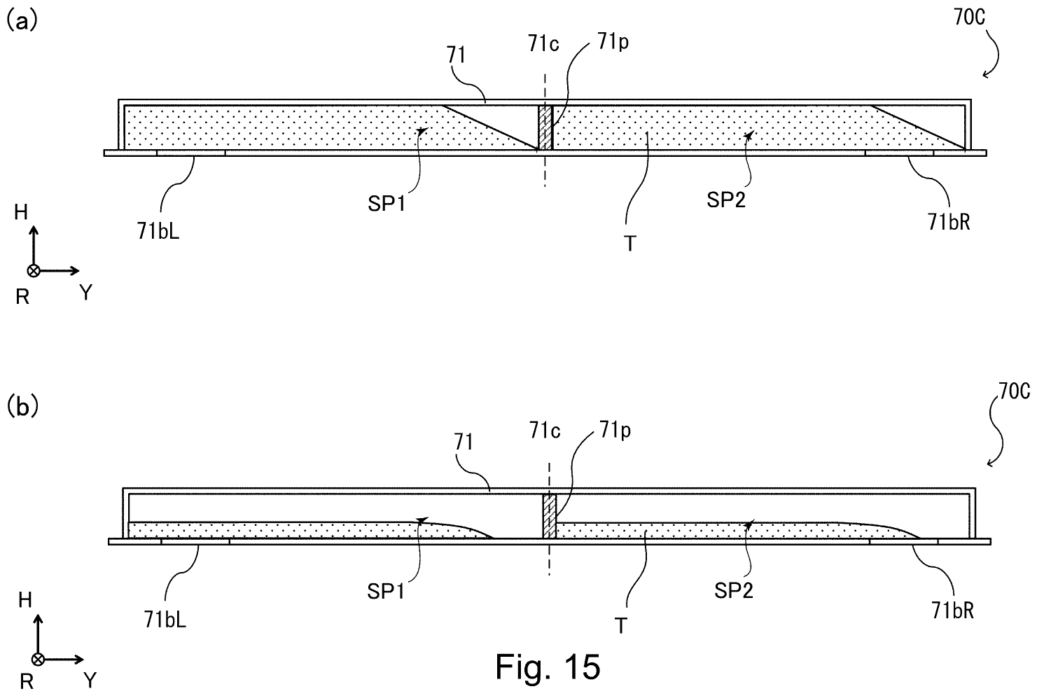

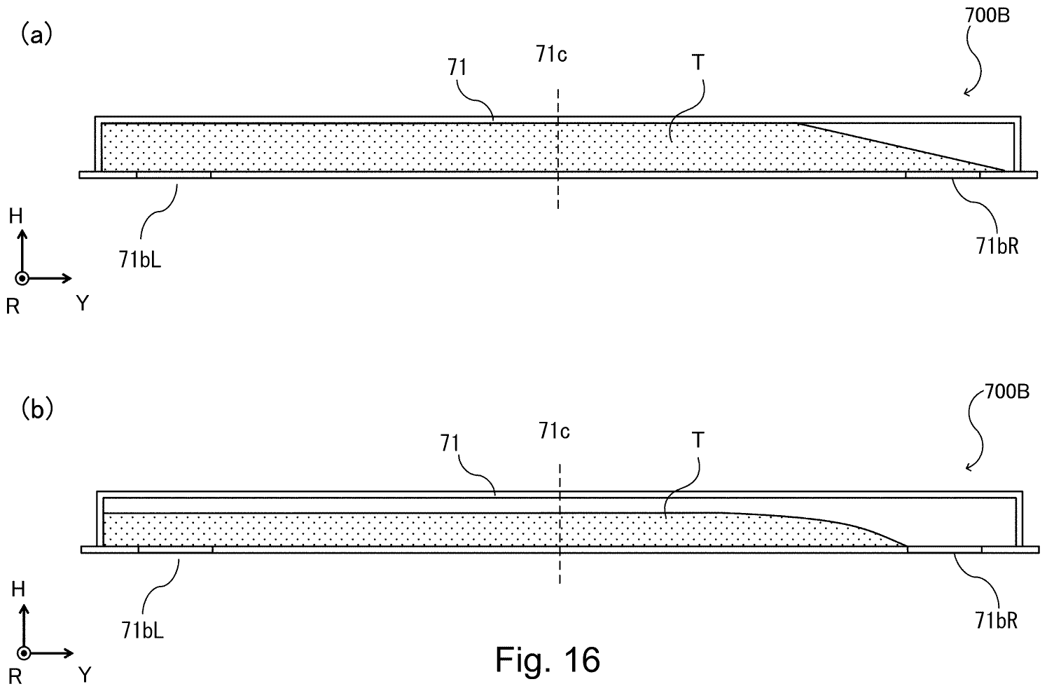

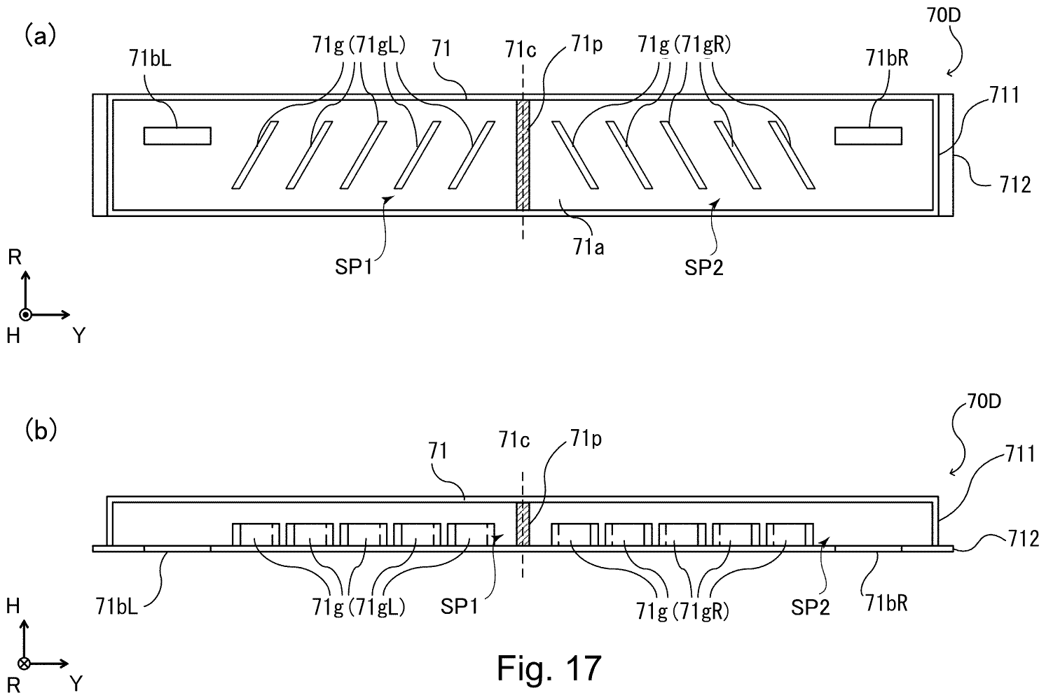

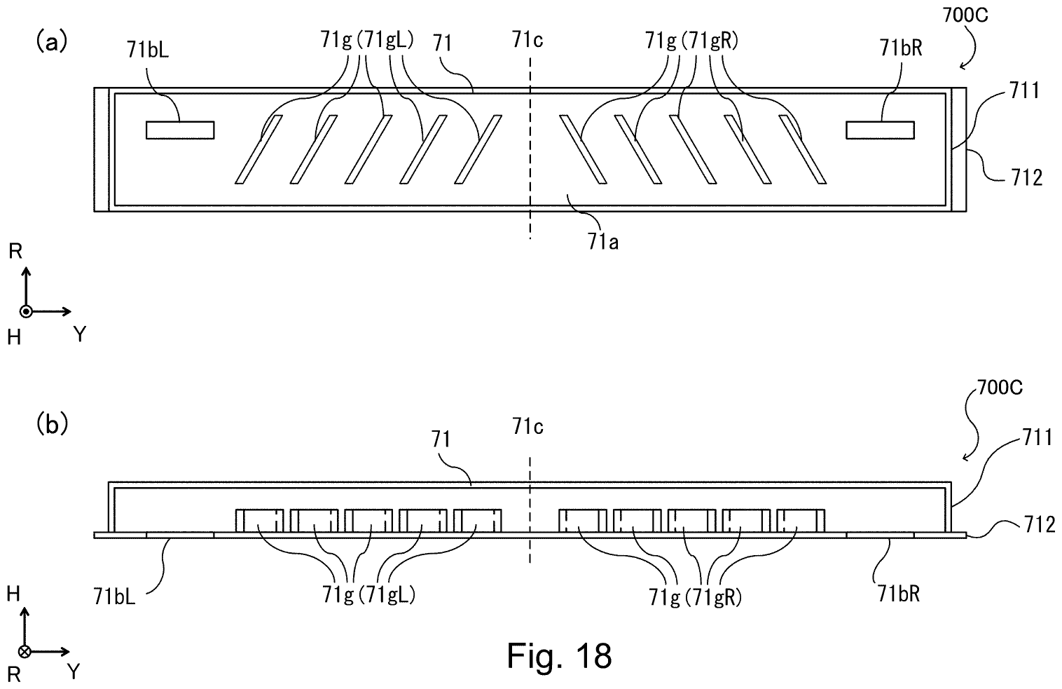

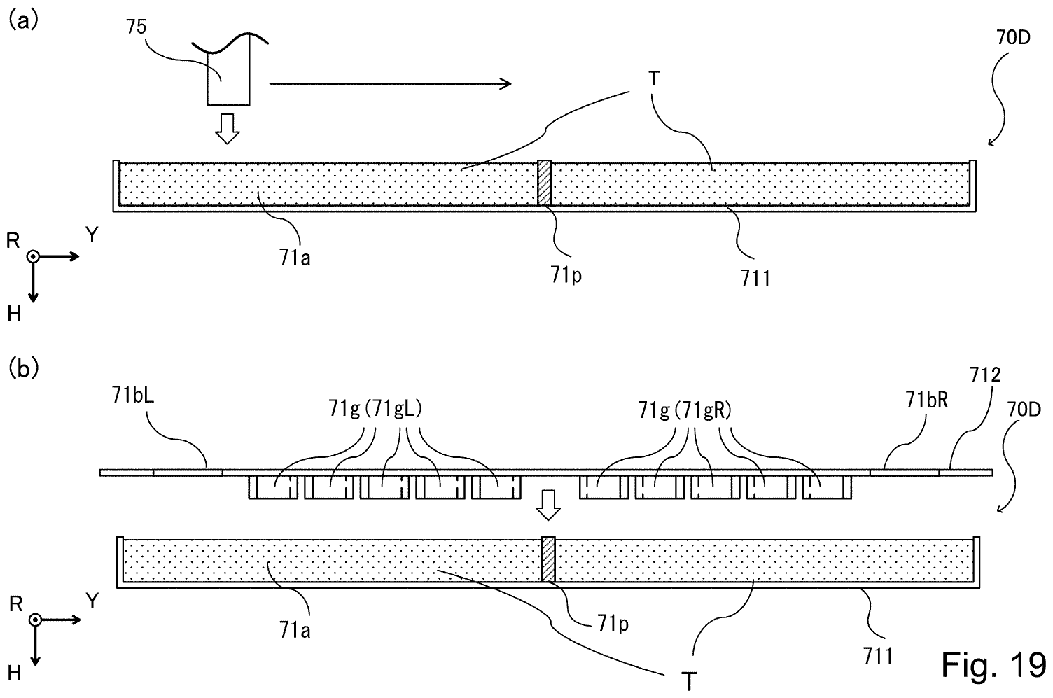

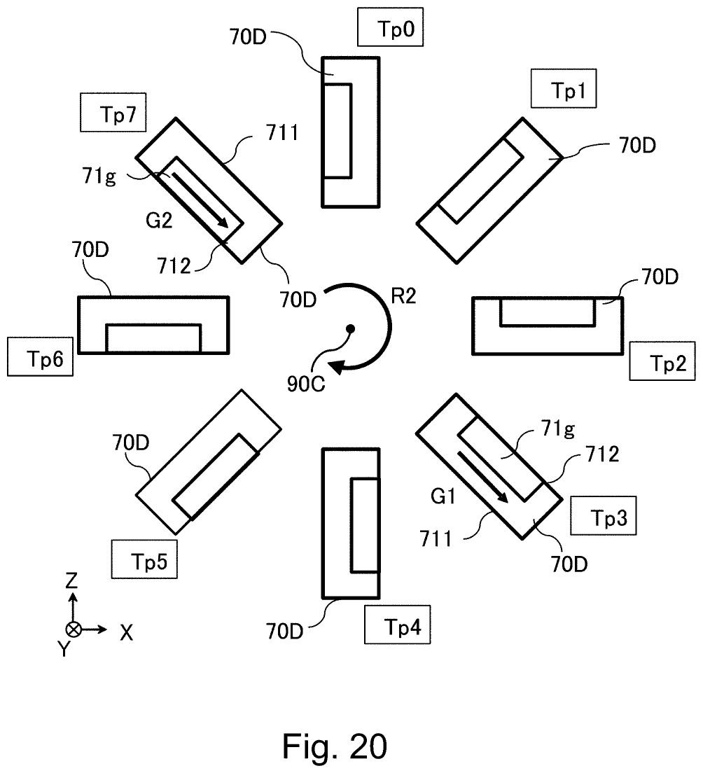

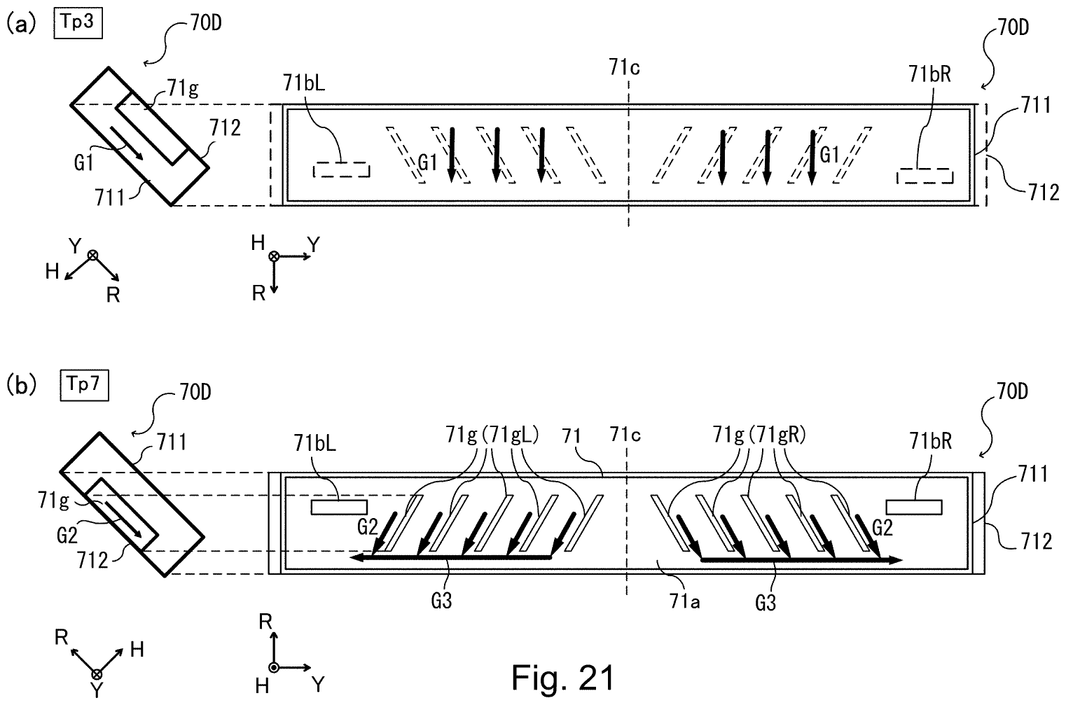

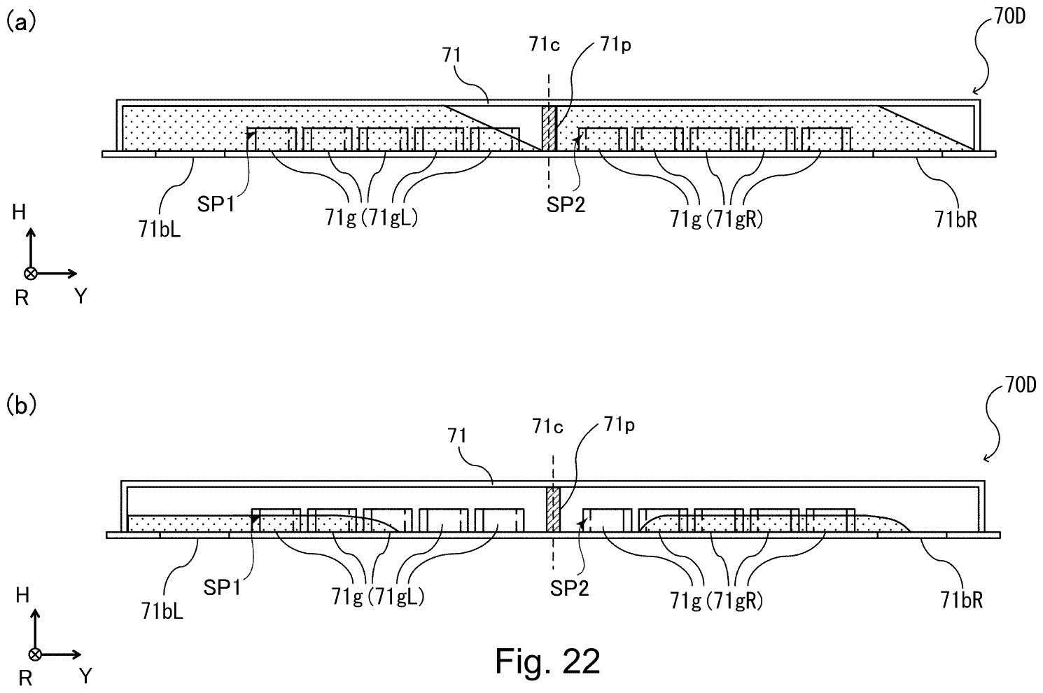

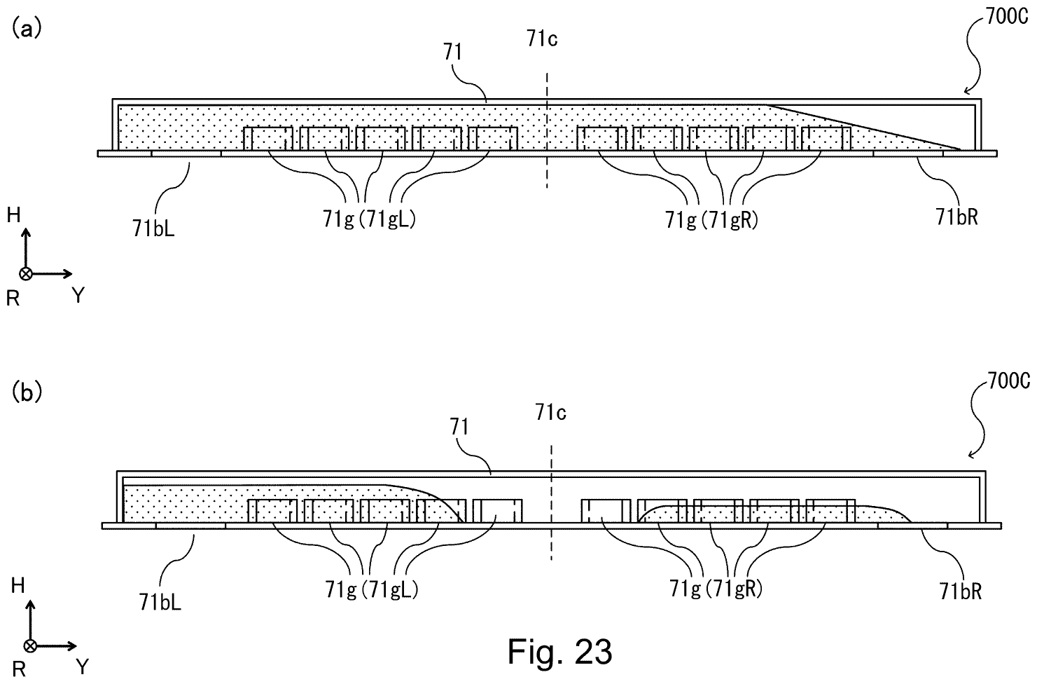

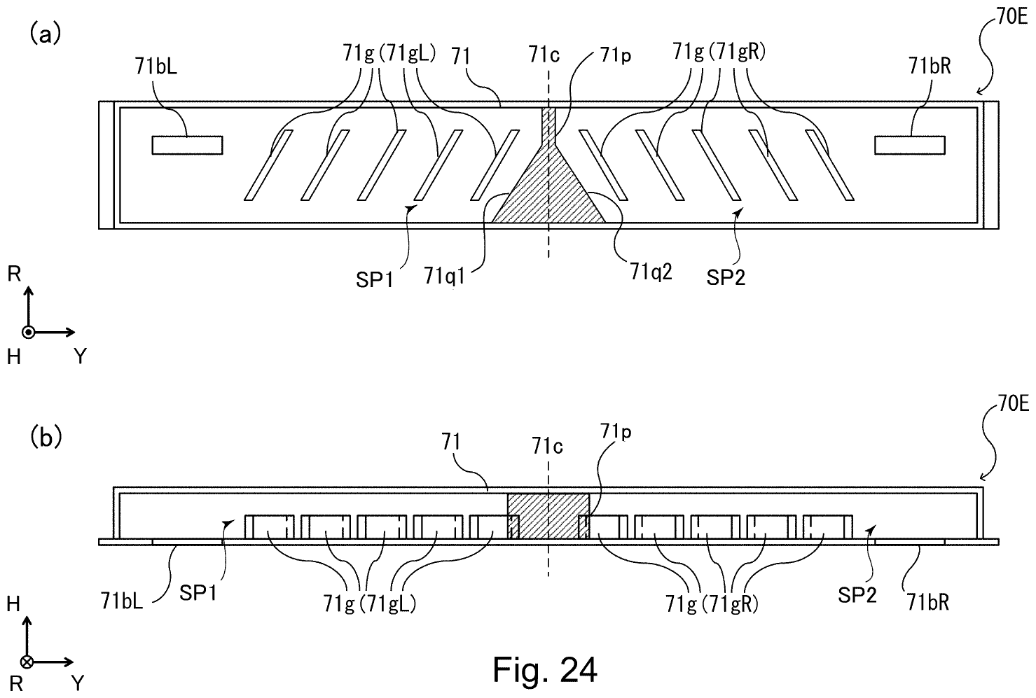

By using FIG. 1, a schematic constitution and an image forming operation of the image forming apparatus 1 will be described. FIG. 1 is a schematic view showing a cross-sectional structure of the image forming apparatus 1.

As shown in FIG. 1, the image forming apparatus 1 includes an image forming apparatus main assembly (hereinafter, referred to as an apparatus main assembly) 1A and toner cartridges 70y, 70m, 70c, and 70k detachably mounted to the apparatus main assembly 1A. The apparatus main assembly 1A is a portion excluding the toner cartridges 70y, 70m, 70c, and 70k from the image forming apparatus 1.

The apparatus main assembly 1A of the image forming apparatus 1 includes an electrophotographic photosensitive member (hereinafter, referred to as a photosensitive drum) 2 having a drum shape (cylindrical shape) as an image bearing member for bearing an electrostatic latent image. At a periphery of the photosensitive drum 2, a charging roller 3, a scanner 4 as an exposure device, and a cleaning unit 6 are provided.

The charging roller 3 is an example of a charging means or a charging unit, which is for electrically charging the photosensitive drum 2 uniformly. The scanner 4 is an example of an exposure means or an exposure unit, which is for performing exposure by irradiating the photosensitive drum 2 with laser light depending on image information.

By irradiating the charged photosensitive drum 2 with the laser light, the electrostatic latent image is formed on a surface of the photosensitive drum 2. The cleaning unit 6 is an example of a cleaning means or a cleaning portion, which is for removing toner remaining on the surface of the photosensitive drum 2.

Further, the apparatus main assembly 1A includes a sheet accommodating portion 300, a pick-up roller 310, a feed roller 311, a separation roller 312, a conveying roller pair 320, a secondary transfer roller 12, a fixing device 40, and an intermediary transfer unit 10. The pick-up roller 310 is an example of a feeding means or a feeding unit, which is for feeding the sheet S. The feed roller 311 and the separation roller 312 are examples of a separation/conveyance unit for conveying sheets S while separating the sheets S one by one by a frictional force. The secondary transfer roller 12 is an example of a transfer portion means or a transfer member, which is for transferring an image from an intermediary transfer belt 10a onto the sheet S.

The intermediary transfer unit 10 includes the intermediary transfer belt 10a, a belt driving roller 10b, a tension roller 10c, a cleaning device 13, and a primary transfer roller 11. The intermediary transfer belt 10a is an example of an intermediary transfer member for carrying and conveying an image, transferred (primarily transferred) from the photosensitive drum 2 thereon, in order to transfer (secondarily transfer) the image onto the sheet S. The intermediary transfer belt 10a is stretched by the belt driving roller 10b and the tension roller 10c. The belt driving roller 10b is a driving member for conveying the intermediary transfer belt 10a by being rotationally driven by a driving source.

Further, the apparatus main assembly 1A includes a rotary main body (rotary, rotatable member, developing device) 90 including the developing units 50y, 50m, 50c, and 50k. As described later, in this embodiment, to the rotary main body 90, trays (supporting members) 80y, 80m, 80c, and 80k are mounted. To the trays 80y, 80m, 80c, and 80k, the toner cartridges 70y, 70m, 70c, and 70k are detachably mounted, respectively.

In the following, a plurality of members similar in function can be discriminated by adding reference numerals or symbols. For example, it is possible that one of the four toner cartridges 70y, 70m, 70c, and 70k is referred to as a first toner cartridge, one of the remaining three toner cartridges is referred to as a second toner cartridge, one of the remaining two toner cartridges is referred to as a third toner cartridge, and the final toner cartridge is referred to as a fourth toner cartridge. Similarly, it is possible that one of the four trays 80y, 80m, 80c, and 80k is referred to as a first tray, one of the remaining three trays is referred to as a second tray, one of the two remaining tray is referred to as a third tray, and the final tray is referred to as a fourth tray. That is, one of the trays 80y to 80k is an example of a first supporting member, another one of the trays 80y to 80k is an example of a second supporting member, a further one of the trays 80y to 80k is an example of a third supporting member, and the final one of the trays 80y to 80k is an example of a fourth supporting member. Numbering of these members is merely used for convenience of explanation, and can be appropriately replaced in principle.

The developing units (first to fourth developing units) 50y, 50m, 50c, and 50k are examples of a developing means or a developing portion, which is for developing (visualizing) the electrostatic latent image, formed on the photosensitive drum 2, with toner of an associated one of the colors. The developing units 50y, 50m, 50c, and 50k develop the electrostatic latent images, formed on the photosensitive drums, with yellow toner, magenta toner, cyan toner, and black toner, respectively. The developing units 50y, 50m, 50c, and 50k may be disposed in an order different from the order thereof shown in FIG. 1.

The developing unit 50y includes the developing roller 51y, a supplying roller 52y, and a developing blade. The developing roller 51y is a developer carrying member rotating while carrying the toner as a developer and supplying the toner to the photosensitive drum 2. The supplying roller 52y is a supply member provided in contact with the developing roller 51y and for supplying the tray to the developing roller 51y. The developing blade is a regulating member for regulating a thickness of a layer of the toner carried on the developing roller 51y. Other developing units 50m, 50c, and 50k are provided with developing rollers 51m, 51c, and 51k, supplying rollers 52m, 52c, and 52k, and developing blades similar to those described above.

### (Rotary Constitution)

By using FIG. 1 to part (b) of FIG. 4, a constitution of the rotary main body 90 will be described. To the rotary main body 90, as shown in FIG. 1, the toner cartridge 70y, 70m, 70c, and 70k corresponding to the developing units 50y, 50m, 50c, and 50k. Inside the toner cartridges 70y, 70m, 70c, and 70k, the yellow toner, the magenta toner the cyan toner, and the black toner are accommodated, respectively, as the toner for being supplied to the developing units 50y, 50m, 50c, and 50k, respectively. It is possible that one of the toner of the four colors is first toner, one of the toner of the remaining three colors is referred to as second toner, one of the toner of the remaining two colors is referred to as third toner, and the final toner is referred to as a fourth toner. For example, it can be said that the black toner is an example of the first toner and the magenta toner is an example of the second toner. Numbering of these toner is merely used for convenience of explanation and can be appropriately replaced in principle.

Here, the rotary main body 90 includes a rotary frame 90f for supporting the developing units 50y, 50m, 50c, and 50k. The developing units 50y, 50m, 50c, and 50k are supported by the rotary frame 90f which are rotatable rotation supporting members.

Further, to the rotary main body 90, the trays 80y, 80m, 80c, and 80k are mounted. A portion including the rotary main body 90 and the trays 80y, 80m, 80c, and 80k in combination can be referred to as a rotary unit 90U. In other words, the rotary unit 90U includes the rotary main body 90 and the trays 80y, 80m, 80c, and 80k.

The toner cartridges 70y to 70k are detachably held by the trays 80y to 80k, respectively. Although described later, the tray 80y to 80k are supported slidably and movably to an outside of the rotary main body 90. A portion including the rotary unit 90U and the toner cartridges 70y, 70m, 70c, and 70k in combination can be referred to as a rotary assembly 90A. In other words, the rotary assembly 90A includes the rotary unit 90U and the toner cartridges 70y, 70m, 70c, and 70k.

The rotary main body 90 is rotatable about the rotational axis (rotation center) 90C. The rotational axis 90C coincides with rotational axes of the rotary frame 90f, the rotary unit 90U, and the rotary assembly 90A. Further, the rotational axis 90C is substantially parallel to a rotational axis (rotation center) of the photosensitive drum 2.

Part (a) of FIG. 2 is a sectional view showing a state in which the rotary main body 90 takes a development attitude, and part (b) of FIG. 2 is a sectional view showing a state in which the rotary main body 90 takes a separation attitude. Part (c) of FIG. 2 is a sectional view showing a state in which the rotary main body 90 takes a stand-by attitude, and part (d) of FIG. 2 is a sectional view showing a state in which the rotary main body 90 takes an exchange attitude.

As shown in FIG. 1 and part (a) of FIG. 2, the rotary main body 90 can take a development attitude, in which either one of the developing rollers 51y, 51m, 51c, and 51k contacts the photosensitive drum 2, by being rotated about the rotational axis 90C.

In each of opposite end portions of the rotary main body 90 with respect to the Y direction, a disk gear is formed, and with the disk gear, an unshown rotary driving gear is engaged. Further, the rotary driving gear is driven by an unshown motor, so that the disk gear and the rotary main body 90 are rotated about the rotational axis 90C.

An attitude in which the developing roller 51y contacts the

photosensitive drum 2 is called a yellow development attitude. An attitude in which the developing roller 51m contacts the photosensitive drum 2 is called a magenta development attitude. An attitude in which the developing roller 51c contacts the photosensitive drum 2 is called a cyan development attitude. An attitude in which the developing roller 51k contacts the photosensitive drum 2 is called a black development attitude. That is, the rotary main body 90 can be rotated about the rotational axis 90C so that positions of the developing rollers 51y, 51m, 51c, and 51k relative to the photosensitive drum 2 change. The black development attitude is an example of a first development attitude in which a first developing roller (developing roller 51k) contacts the photosensitive drum 2.

Other development attitudes are examples of a second development attitude in which second developing rollers (developing rollers 51y to 51c contact the photosensitive drum 2. The yellow/magenta/cyan/black development attitudes can also be called first to fourth development attitudes. Numbering of these development attitudes is merely used for convenience of explanation and can be appropriately replaced in principle.

Here, suffixes y, m, c, and k added in the forms such as the developing units 50y, 50m, 50c, and 50k, the toner cartridges 70y, 70m, 70c, and 70k, and the trays 80y, 80m, 80c, and 80k show the colors of the toner. Basic structures and functions of the developing units 50y, 50m, 50c, and 50k are in common.

Basic structures and functions of the toner cartridges 70y, 70m, 70c, and 70k are in common. Basic structures and functions of the trays 80y, 80m, 80c, and 80k are in common. Accordingly, in the case where there is no need to distinguish the respective members, the suffixes y, m, c, and k are omitted, and the members will be described as arbitrary one of the four units, the four cartridges, or the four trays. Further, in the case where there is a need to distinguish each of the four units, the four cartridges, or the four trays, the suffixes y, m, c, and k are added to the members, and each of the members will be described as the member corresponding to the associated suffix.

Further, the rotary main body 90 is swingably supported about the swing shaft 91. The rotary main body 90 is urged about the swing shaft 91 in the counterclockwise direction in FIG. 1 to part (d) of FIG. 2 by an unshown urging member. This direction can be said as a direction in which each of the developing rollers 51y to 51k approaches the photosensitive drum 2. As a result, in a state in which the rotary main body 90 takes the development attitude, each of the developing rollers 51y to 51k contacts the photosensitive drum 2.

Incidentally, in part (a) of FIG. 2, the rotary main body 90 takes the black development attitude in which the developing roller 51k contacts the photosensitive drum 2.

As shown in FIG. 1, the apparatus main assembly 1A includes a frame 16 accommodating the rotary main body 90.

The frame 16 is a main assembly frame of the image forming apparatus 1 of this embodiment. The frame 16 is a casing (frame work) of the apparatus main assembly 1A constituted by a frame or an outer casing member, and has a substantially rectangular parallelopiped shape. The frame 16 rotatably supports a cam 96, and the cam 96 is constituted so as to be contactable to the rotary main body 90. Then, when the cam 96 is rotated, the rotary main body 90 is pressed by the cam 96, whereby the rotary main body 90 is rotated about the swing shaft 91 in the clockwise direction indicated by an arrow of a broken line in part (b) of FIG. 2. This direction can be said as a direction in which each of the developing rollers 51y to 51k is moved away from the photosensitive drum 2. Further, this direction can be said as a direction in which the rotary main body 90 approaches an opening 16a and a door 14. By this, the developing roller 51k provided in the rotary main body 90 is separated from the photosensitive drum 2. Thus, an attitude of the rotary main body 90 in a state in which the developing roller 51 is separated from the photosensitive drum 2 while opposing the photosensitive drum 2 is referred to as the separation attitude.

Further, when the image forming apparatus 1 waits for execution of image formation, the rotary main body 90 takes, as shown in part (c) of FIG. 2, the stand-by attitude in which the photosensitive drum 2 is positioned between the developing roller 51c and the developing roller 51k. Further, when a user exchanges the toner cartridge 70, the rotary main body 90 takes the exchange attitude shown in part (d) of FIG. 2. When the rotary main body 90 takes the exchange attitude, the photosensitive drum 2 and the developing roller 51 are separated from each other, and either one of the toner cartridges 70 takes an attitude along a substantially horizontal direction. In part (d) of FIG. 2, the toner cartridge 70k for black takes an attitude along the horizontal direction.

As described above, the toner cartridges 70y to 70k are detachably mountable to the rotary main body 90. In the case where the toner in each of the toner cartridges 70y to 70k is used up, the user exchanges the associated one of the toner cartridges 70y to 70k, so that the toner can be supplied to the image forming apparatus 1.

Next, using FIG. 1 and parts (a) and (b) of FIG. 3, mounting of the toner cartridge 70k to the rotary main body 90 and demounting of the toner cartridge 70k from the rotary main body 90 will be described. Part (a) of FIG. 3 is a sectional view showing a state in which the tray 80k and the toner cartridge 70k are accommodated in the rotary main body 90, and part (b) of FIG. 3 is a sectional view showing a state in which the tray 80k and the toner cartridge 70k are pulled out from the rotary main body 90.

As shown in FIG. 1 and parts (a) and (b) of FIG. 3, the frame 16 is provided with the opening 16a. Specifically, the frame 16 is provided with a side surface 16b expanding in a direction crossing the horizontal direction. The side surface 16b constitutes at least a part of an outer appearance surface of the apparatus main assembly 1A on +X side. The opening 16a is provided in this side surface 16b. The side surface 16b is a side surface disposed on a side downstream of a discharge opening with respect to a discharge direction in which the sheet S on which the image is formed is discharged through the discharge opening of the apparatus main assembly 1A. The user is capable of replenishing the sheets S by accessing the sheet accommodating portion 300 from a side of the side surface 16b of the image forming apparatus 1 or acquiring the sheet S discharged through the discharge opening. For that reason, the side surface 16b can be said as a front surface (front side) of the apparatus main assembly.

The toner cartridges 70y, 70m, 70c, and 70k are detachably mountable to the rotary main body 90 through the opening 16a. That is, the toner cartridge 70k can be said as an example of a first toner cartridge accommodating the tray supplied to a first developing roller (developing roller 51k) and detachably mountable to the rotary (rotary main body 90) through the opening 16a of the frame 16 of the apparatus main assembly 1A. The toner cartridge 70m can be said as an example of a second toner cartridge accommodating the tray supplied to a second developing roller (developing roller 51m) and detachably mountable to the rotary (rotary main body 90) through the opening 16a of the frame 16 of the apparatus main assembly 1A.

In this embodiment, the toner cartridges 70y, 70m, 70c, and 70k are mounted to and demounted from the rotary main body 90 through the opening 16a in a state in which these toner cartridges 70y to 70k are supported by the trays 80y to 80k. In other words, the user is capable of mounting and demounting the toner cartridges 70y to 70k relative to the rotary main body 90 through the trays 80y to 80k.

In this embodiment, the side surface 16b is a surface substantially parallel to the rotational axis 90C of the rotary main body 90. For this reason, in the case where the toner cartridge 70 is exchanged, the toner cartridge 70 passes through the opening 16a in a direction crossing (preferably perpendicular to) the rotational axis 90C.

The image forming apparatus 1 includes the door 14 covering the opening 16a of the frame 16. The door 14 is an openable (/closable) member movable to a closed position where the door 14 covers and closes the opening 16a (position of part (a) of FIG. 3) and an open position where the opening 16a is exposed (position of part (b) of FIG. 3).

As described above, in this embodiment, the toner cartridge 70 is constituted so as to be detachably mountable to the rotary main body 90 through the tray 80. For this reason, the toner cartridge 70 can be stably mounted to and demounted from the rotary main body 90.

Specifically, the user is capable of exchanging the toner cartridge 70 by an operation of mounting and demounting the toner cartridge 70 relative to the tray 80 constituted so as to be movable relative to the rotary main body 90 (i.e., relative to the apparatus main assembly 1A). In the case of a constitution in which the user exchanges the toner cartridge by directly inserting and extracting the toner cartridge relative to the apparatus main assembly, the user is required to insert the toner cartridge to a predetermined mounting position in the apparatus main assembly. In this embodiment, in a state in which the tray 80 supports the toner cartridge 70, the tray 80 is movable so that the toner cartridge 70 is moved to the mounting position. For that reason, the user is capable of exchanging the toner cartridge 70 by a simple operation of placing the toner cartridge 70 on the tray 80, so that an operating property is improved.

Incidentally, the toner cartridge 70 has a thin and elongated shape with

respect to Y direction, as a longitudinal direction, parallel to the rotational axis 90C of the rotary main body 90. That is, a dimension of the toner cartridge 70 in the longitudinal direction is more than a height and a width in a cross section perpendicular to the longitudinal direction. Thus, in the case where the toner cartridge 70 having the thin and elongated shape is handled, by disposing the opening 16a in the side surface 16b of the frame 16 substantially parallel to the longitudinal direction (Y direction) of the toner cartridge 70, the toner cartridge 70 is capable of being passed through the opening 16a in a short movement distance. For example, the exchange of the toner cartridge becomes easy compared with the case where the toner cartridge 70 is inserted and extracted through an opening provided in a side surface on either one side (+Y side or −Y side) of the frame 16 with respect to the longitudinal direction of the toner cartridge 70.

The rotary main body 90 is capable of taking an exchange attitude in which demounting (removal) of either one of the toner cartridges 70y to 70k from the rotary main body 90 is permitted by being rotated about the rotational axis 90C. An attitude in which the demounting of the toner cartridge 70y is permitted is called a yellow exchange attitude. An attitude in which the demounting of the toner cartridge 70m is permitted is called a magnetic exchange attitude. An attitude in which the demounting of the toner cartridge 70c is permitted is called a cyan exchange attitude. An attitude in which the demounting of the toner cartridge 70k is permitted is called a black exchange attitude. The black exchange attitude is an example of a first exchange attitude in which the demounting of the first toner cartridge from the rotary main body 90 is permitted. Each of the yellow/magenta/cyan exchange attitudes is an example of a second exchange attitude in which the demounting of the second toner cartridge from the rotary main body 90 is permitted. The yellow/magenta/cyan/black exchange attitudes can also be called first to fourth exchange attitudes, respectively. Numbering of these exchange attitudes is merely used for convenience of explanation and can be appropriately replaced in principle.

The rotary main body 90 is rotated about the rotational axis 90C in the clockwise direction in FIG. 1, so that the rotary main body 90 is capable of successively taking the yellow/magenta/cyan/black exchange attitudes. In parts (a) and (b) of FIG. 3, the rotary main body 90 takes the black development attitude.

As shown in parts (a) and (b) of FIG. 3, to the rotary main body 90, the four trays 80y to 80k are mounted. On the trays 80y to 80k, the toner cartridges 70y to 70k are held, respectively. In part (a) of FIG. 3, the trays 80y to 80k are in a state in which these trays are accommodated inside the rotary main body 90, and this state can also be said as a state in which the toner cartridges 70y to 70k are mounted to the developing units 50y to 50k, respectively.

As described above, the toner cartridge 70 is movable to the mounting position relative to the developing frame 53 of the developing unit 50 and the retracted position retracted from the mounting position (rotary main body 90). That is, the first toner cartridge (toner cartridge 70k) is movable to a first mounting position and a first retracted position relative to the first accommodating frame (developing frame 53k). The second toner cartridge (toner cartridge 70m) is movable to a second mounting position and a second retracted position relative to the second accommodating frame (developing frame 53m).

For example, when the toner cartridge 70k for black is demounted from the rotary main body 90, as shown in part (a) of FIG. 3, the rotary main body 90 takes the black exchange attitude. At this time, the rotary main body 90 stops in a position where the toner cartridge 70k opposes the opening 16a and the door 14. Then, the door 14 is moved from the closed position to the open position, so that the opening 16a provided in the side surface 16b of the frame 16 is opened (exposed). Next, the tray 80k is slid and moved from an accommodating position where the tray 80k is accommodated in the rotary main body 90 to a pulling-out position outside the frame 16. In a state in which the tray 80k is positioned in the pulling-out position, the toner cartridge 70k is in the retracted position, so that the user can be mount the toner cartridge 70k from the tray 80. Further, when the toner cartridge 70k is mounted to the rotary main body 90, the mounting of the toner cartridge 70k is performed in a procedure reverse to the above-described procedure.

In this embodiment, the toner cartridge 70k accommodating the black toner is larger in size than each of the toner cartridges 70y to 70c accommodating the yellow toner, the magenta toner, and the cyan toner, respectively, and is capable of accommodating the toner in a large amount. In other words, the first toner cartridge is capable of accommodating the toner in a first amount and the second toner cartridge is capable of accommodating the toner in a second amount, and it can be said that the first amount is larger than the second amount.

Specifically, a length of the toner cartridge 70k for black in a first radial direction relative to the rotational axis 90C of the rotary main body 90 is longer than a length of the toner cartridge 70m for magenta in a second radial direction. Here, the first radial direction is a direction which is a rotation radius direction of the rotary main body 90 (radial direction of a virtual circle about the rotational axis 90C) and in which the toner cartridge 70k extends relative to the rotational axis 90C as viewed in a direction of the rotational axis 90C. The second radial direction is a direction which is a rotation radius direction of the rotary main body 90 and in which the toner cartridge 70m extends relative to the rotational axis 90C as viewed in the direction of the rotational axis 90C. Similarly, the length of the toner cartridge 70k for black in the first radial direction is longer than lengths of other toner cartridges 70y and 70c in radial directions corresponding to the toner cartridges 70y and 70c.

For that reason, the tray 80k holding the toner cartridge 70k for black is larger in size than each of the trays 80y to 80c holding other toner cartridges 70y to 70c, respectively. That is, in the rotary main body 90, the four toner cartridges 70y to 70k and the four trays 80y to 80k, which are different in size are disposed. In other words, to the rotary main body 90, the toner cartridge 70k as the example of the first toner cartridge and the toner cartridge 70y as the example of the second toner cartridge smaller in size than the first toner cartridge are detachably mountable. Correspondingly thereto, in the rotary main body 90, the tray 80k as an example of the first supporting member for supporting the first toner cartridge and the tray 80y as an example of the second supporting member smaller in size than the first supporting member are provided. Further, to the rotary main body 90, the toner cartridges 70m and 70c as examples of the third toner cartridge and the fourth toner cartridge which are smaller in size than the first toner cartridge are detachably mountable. Correspondingly thereto, in the rotary main body 90, the trays 80m and 80c as examples of the third supporting member and the fourth supporting member which are smaller in size than the first supporting member are provided.

Parts (a) and (b) of FIG. 4 are schematic views showing the developing frame 53 and the toner cartridge 70 mounted to the developing frame 53. As shown in part (a) of FIG. 4, the toner cartridge 70 includes a toner (cartridge) frame 71 as a frame. The toner frame 71 is provided with a toner accommodating portion 71a as an accommodating portion for accommodating the toner and a discharge opening 71b communicating with the toner accommodating portion 71a. As regards the discharge opening 71b, a plurality of discharge openings 71b are provided with respect to the Y direction, i.e., the longitudinal direction of the toner cartridge 70.

The developing unit 50 includes the developing frame (accommodating frame) 53. The developing frame 53 is provided with a development-side accommodating portion 53a (accommodating portion) and a receiving opening 53b communicating with the development-side accommodating portion (toner supplying chamber) 53a. As regards the receiving opening 53b, a plurality of receiving openings 53b are provided with respect to the Y direction, i.e., the longitudinal direction of the toner cartridge 70, and are provided in the same number as the discharge openings 71b. That is, the rotary main body 90 is provided with a developing frame 53y, a developing frame 53m, a developing frame 53c, and a developing frame 53k (see part (a) of FIG. 3). That is, the rotary main body 90 includes a first developing chamber, a second developing chamber, a third developing chamber, and a fourth developing chamber. Incidentally, as described above, the developing unit 50 includes the developing roller 51, the supplying roller 52, and the like, but these members are omitted in parts (a) and (b) of FIG. 4.

The developing roller 51k provided in the developing unit 50k is an example of a first roller. The developing roller 51m provided in the developing unit 50m is an example of a second roller. The developing frame 53k (part (a) of FIG. 3) of the developing unit 50k provided with the development-side accommodating portion 53a is an example of a first accommodating frame provided with a first accommodating portion. The developing frame 53m (part (a) of FIG. 3) of the developing unit 50m provided with the development-side accommodating portion 53a. The rotary main body 90 is an example of a rotatable rotary including the first developing roller, the second developing roller, the first accommodating frame provided with the first accommodating portion, and the second developing frame provided with the second accommodating portion. In this embodiment, the rotary main body 90 includes the first to fourth developing rollers and the first to fourth developing frames.

As shown in part (a) of FIG. 4, in a state in which the toner cartridge 70 is in the mounting position relative to the developing frame 53, the discharge opening 71b opposes the receiving opening 53b. That is, the toner accommodating portion 71a of the toner cartridge 70 and the development-side accommodating portion 53a of the developing unit 50 communicate with each other through a communicating portion 60 constituted by the discharge opening 71b and the receiving opening 53b. Although details will be described later, when the toner is supplied from the toner cartridge 70 to the developing unit 50, a direction of the communicating portion 60 becomes a downward direction (−Z direction) of a vertical direction than the horizontal direction. The direction of the communicating portion 60 is a direction from the discharge opening 71b toward the receiving opening 53b, and in the following, is illustrated as a communicating direction E1. When the toner is supplied from the toner cartridge 70 to the developing unit 50, at least a part of the receiving opening 53b is positioned below at least a part of the discharge opening 71b.

Then, the toner accommodated in the toner accommodating portion 71a is discharged through the discharge opening 71b, so that the toner discharged through the discharge opening 71b is accommodated in the development-side accommodating portion 53a through the receiving opening 53b. That is, a first developer is supplied to the first developing chamber included in the rotary main body 90, a second developer is supplied to the second developing chamber included in the rotary main body 90, a third developer is supplied to the third developing chamber included in the rotary main body 90, and a fourth developer is supplied to the fourth developing chamber included in the rotary main body 90.

The toner accommodated in the development-side accommodating portion 53a is supplied to the developing roller 51 by the supplying roller 52. A long such a path, the toner accommodated in the toner accommodating portion 71a is supplied to the developing roller 51.

The toner cartridge 70 may desirably include an unshown sealing member (first sealing member) covering the discharge opening 71b. Further, the developing unit 50 may desirably include a sealing member 55 (second sealing member) covering the receiving opening 53b as shown in parts (a) and (b) of FIG. 4. The sealing member 55 is provided rotatably about a rotation shaft 55a provided at an end thereof, and opens and closes the receiving opening 53b by being rotated by gravitation exerted on the sealing member 55. For example, as shown in part (a) of FIG. 4, when the developing unit 50 takes an attitude such that the direction of the communicating portion 60 is the downward direction (−Z direction) of the vertical direction than the horizontal direction, the sealing member 55 opens the receiving opening 53b and does not prevent movement of the toner passing through the communicating portion 60. Further, for example, as shown in part (b) of FIG. 4, when the developing unit 50 takes an attitude such that the direction of the communicating portion 60 is an upward direction (+Z direction) of the vertical direction than the horizontal direction, the sealing member 55 closes the receiving opening 53b and prevents the movement of the toner from passing through the communicating portion 60. That is, the sealing member 55 functions as a non-return valve for permitting passing of the toner only in one direction.

Further, in a state in which the toner cartridge 70 is not mounted to the developing unit 50, in order to suppress flowing-out of the toner through the discharge opening 71b and the receiving opening 53b, each of the discharge opening 71b and the receiving opening 53b may desirably be covered with the sealing member.

### (Image Forming Operation)

Next, an image forming operation in this embodiment will be described. When the image forming apparatus 1 receives image information from an external device (not shown) such as a host computer, the image forming apparatus 1 transmits a print signal and starts the image forming operation. First, in a state in which the rotary main body 90 takes the stand-by attitude, the photosensitive drum 2 is rotated in an arrow R1 direction (counterclockwise direction) in FIG. 1 in synchronism with rotation of the intermediary transfer belt 10a. Then, the surface of the photosensitive drum 2 is electrically charged uniformly by the charging roller 3.

In the case where the color image is formed on the sheet S, the rotary main body 90 is rotated in an arrow R 2 direction (clockwise direction) in FIG. 1 while supporting the developing units 50y, 50m, 50c, and 50k. First, the scanner 4 irradiates the photosensitive drum surface with laser light based on image data corresponding to a yellow image so that an electrostatic latent image corresponding to the yellow image is formed on the surface of the photosensitive drum 2. In parallel to formation of this electrostatic latent image, the rotary main body 90 is rotated by an unshown DC brush motor.

That is, the rotary main body 90 is rotated about the rotational axis 90C in the arrow R2 direction in FIG. 1 from the stand-by attitude shown in part (c) of FIG. 2. Then, the cam 96 is rotated in a state in which the developing roller 51y opposes the photosensitive drum 2, so that the rotary main body 90 is swung about the swing shaft 91 and thus takes the yellow development attitude. At this time, the developing roller 51k contacts the photosensitive drum 2. When the rotary main body 90 takes the yellow development attitude, the developing roller 51y is in the developing position, and the electrostatic latent image formed on the photosensitive drum 2 is developed with yellow toner.

Here, in this embodiment, each of the developing rollers 51y, 51m, 51c, and 51k is an elastic roller obtained by coating a metal shaft with a rubber. In the developing position, each of the developing rollers 51y, 51m, 51c, and 51k develops the electrostatic latent image in a state in which the developing roller contacts the photosensitive drum 2. That is, in the image forming apparatus 1 of this embodiment, a contact development type is employed. However, in the developing position, each of the developing rollers 51y, 51m, 51c, and 51k may develop the electrostatic latent image in a state in which a gap is formed between itself and the photosensitive drum 2. That is, the image forming apparatus 1 may employ a non-contact development type.

When the electrostatic latent image is developed into a yellow toner image, the yellow toner image on the photosensitive drum 2 is primarily transferred onto the intermediary transfer belt 10a by the primary transfer roller 11 disposed inside the intermediary transfer belt 10a.

Thereafter, by rotating the rotary main body 90, the developing rollers 51m, 51c, and 51k are successively moved to the developing position, so that toner images of the associated colors are formed. After the yellow toner image is formed on the intermediary transfer belt 10a, the cam 96 is rotated, so that the developing roller 51y is separated from the photosensitive drum 2, and the rotary main body 90 is rotated about the rotational axis 90C. Thereafter, the cam 96 is rotated again, so that the developing roller 51m contacts the photosensitive drum 2, and thus the rotary main body 90 takes the magenta development attitude. Then, the electrostatic latent image formed on the photosensitive drum 2 is developed with magenta toner.

Incidentally, in this embodiment, during a contact/separation operation in which the developing roller 51 is contacted to or separated from the photosensitive drum 2, the rotary main body 90 is not rotated, but the present invention is not limited thereto. For example, in order to shorten an image forming time, the contact/separation operation between the developing roller 51 and the photosensitive drum 2 may be performed while rotating the rotary main body 90. However, in that case, in order that vibration when the developing roller 51 is contacted to or separated from the photosensitive drum 2 does not have the influence on the image forming operation such as the charging and the exposure, there is need to carry out rising and lowering of a rotary rotating speed in a time longer than a time in a conventional constitution.

After the magenta toner image is formed on the intermediary transfer belt 10a, the rotary main body 90 takes the cyan development attitude, so that a cyan toner image is formed on the intermediary transfer belt 10a. After the cyan toner image is formed on the intermediary transfer belt 10a, the rotary main body 90 takes the black development attitude, so that a black toner image is formed on the intermediary transfer belt 10a.

After the black toner image is formed on the intermediary transfer belt 10a, in the case where a color image is continuously formed, the rotary main body 90 is rotated about the rotation axis 90C in the arrow R2 direction (clockwise direction) shown in FIG. 1, so that the attitude of the rotary main body 90 returns to the yellow development attitude. In the case where the color image is not continuously formed, the attitude of the rotary main body 90 returns to the stand-by attitude. Incidentally, the color of the image first formed on the intermediary transfer belt is arbitrary, so that for example, the black toner image may be formed first.

Further, primary transfer is repeated so that the toner images of the four colors are superposed on the intermediary transfer belt 10a, so that a color image is formed on the intermediary transfer belt 10a. Incidentally, in a period until the color image is formed on the intermediary transfer belt 10a, the secondary transfer roller 12 and the cleaning device 13 do not contact the intermediary transfer belt 10a. After the color image is formed on the intermediary transfer belt 10a, the secondary transfer roller 12 and the cleaning device 13 contact the intermediary transfer belt 10a and prepare for secondary transfer.

On the other hand, the sheet S is fed by the pick-up roller 310 from the sheet accommodating portion 300 provided in a lower portion of the apparatus main assembly 1A. The sheet S is sent to the conveying roller pair 320 in a state in which the sheets S are separated one by one by the feed roller 311 and the separation roller 312. The conveying roller pair 320 sends the fed sheet S to a transfer portion (secondary transfer portion) which is a nip between the intermediary transfer belt 10a and the secondary transfer roller 12. The color image on the intermediary transfer belt 10a is transferred (secondary transferred) onto a surface of the conveyed sheet S.

The sheet S on which the color image is transferred is set to the fixing device 40. In the fixing device 40, the sheet S is heated and pressed, so that the image is fixed on the sheet S. The sheet S passed through the fixing device 40 is discharged as a product to an outside of the image forming apparatus 1.

On the other hand, in the case where a black monochromatic image is formed on the sheet S, the rotary main body 90 takes the black development attitude. In this state, the electrostatic latent image is formed on the surface of the photosensitive drum 2 by the charging and the exposure of the photosensitive drum 2, and thereafter, the electrostatic latent image is developed with the black toner by the developing roller 51k positioned in the developing position. In the case where the black monochromatic images are continuously formed, the rotary main body 90 continues the development while maintaining the black development attitude. In the case where the black monochromatic images are not continuously formed, the rotary main body 90 returns to the stand-by attitude.

The black toner image is primarily transferred onto the intermediary transfer belt 10a and thereafter is secondarily transferred onto the sheet S. Subsequent steps are similar to those in the case of the color image.

### (Toner Supplying Operation)

Next, by using parts (a) to (e) of FIG. 5, a toner supplying operation for supplying the toner from the toner cartridge 70 to the developing unit 50 will be described. Part (a) of FIG. 5 is a schematic view showing an attitude of the toner cartridge 70 such that toner supply is started. Parts (b) to (d) of FIG. 5 re schematic views showing an attitude of the toner cartridge 70 during the toner supply. Part (e) of FIG. 5 is a schematic view showing an attitude of the toner cartridge 70 such that the toner supply is completed.

The attitude of the rotary main body 90 when the toner is supplied from the toner cartridge 70 to the developing unit 50 when the rotary main body 90 is rotated once about the rotational axis 90C is called a supply attitude. Incidentally, in this embodiment, the toner cartridge 70 is provided with a plurality of discharge openings 71b, but in the following, for simplicity, description will be made by paying attention to toner supply through a single discharge opening 71b.

As described above, the toner accommodated in the toner accommodating portion 71a of the toner cartridge 70 is discharged through the discharge opening 71b and is accommodated in the development-side accommodating portion 53a through the receiving opening 53b. Such a supplying operation is performed by movement of the toner by gravitation. For this reason, the rotary main body 90 takes the supply attitude when the toner cartridge 70 for performing the toner supply and the communicating direction E1 of the communicating portion 60 of the developing frame 53 become a downward direction of the vertical direction than the horizontal direction.

For example, the supply attitude of the rotary main body 90 is started from an attitude such that the communicating direction E1 is rotated even slightly in the arrow R2 direction (clockwise direction) from a state in which the communicating direction E1 is parallel to the horizontal direction as shown in part (a) of FIG. 5. Further, the supply attitude of the rotary main body 90 continues to a range immediately before a state in which the communicating direction E1 becomes parallel to the horizontal direction again as shown in part (e) of FIG. 5 is formed by way of attitudes in which the communicating direction E1 becomes the downward direction of the vertical direction than the horizontal direction as shown in parts (b) to (d) of FIG. 5.

On the other hand, in an attitude such that the communicating direction E1 of the communicating portion 60 becomes parallel to the horizontal direction or becomes an upward direction of the vertical direction than the horizontal direction, the communicating portion 60 is closed (shielded) by the sealing member 55. For this reason, it is possible to suppress back-flow of the toner from the development-side accommodating portion 53a of the developing unit 50 to the toner accommodating portion 71a of the toner cartridge 70.

When the rotary main body 90 takes the above-described supply attitude, the toner accommodated in the toner accommodating portion 71a is discharged through the discharge opening 71b and conveyed to the development-side accommodating portion 53a of the developing unit 50 through the receiving opening 53b. The toner accommodated in the development-side accommodating portion 53a is supplied to the developing roller 51. A long such a path, the toner accommodated in the toner accommodating portion 71a is supplied to the developing roller 51.

### (Partitioning Portion of Toner Cartridge)

Here, the toner filled in the toner cartridge 70 is localized inside the toner cartridge 70 in some cases by an attitude of the toner cartridge 70 during transportation until the toner cartridge 70 reaches a user's place or during storage.

For example, as shown in FIG. 9, in the case where the attitude of the toner cartridge 70 during the transportation is such that an end portion of the toner cartridge 70 with respect to a longitudinal direction (Y direction) is directed downward, the toner in the toner cartridge 70 is localized on the above-described end portion side, i.e., a downstream side with respect to the direction of gravitation. In this state, even when the attitude of the toner cartridge 70 is returned to an attitude thereof during use, the toner inside the toner cartridge 70 is still localized in some cases. In a state in which the inside toner is localized, amounts of the toner passing through the plurality of discharge openings 71b disposed in parallel with respect to the Y direction are different from each other, so that the supply of the toner to the developing unit 50 becomes non-uniform. When the supply of the toner to the developing unit 50 becomes non-uniform, there is a possibility of an occurrence of image defect such as a poor density such that an image density becomes poor (low) in a part of an image region and a white void such that a part of an image is not printed.

Therefore, in this embodiment, by providing a partitioning portion 71p inside the toner cartridge 70, even when the toner in the toner cartridge 70 is localized due to the transportation or the like, non-uniform toner supply through the plurality of discharge openings 71b is alleviated, so that the occurrence of the image defects such as the poor density and the white void can be suppressed. By using parts (a) and (b) of FIG. 6, the partitioning portion 71p in this embodiment will be described. Part (a) of FIG. 6 is a sectional view showing a cross section perpendicular to a thickness direction (H direction) of the toner cartridge 70, and part (b) of FIG. 6 is a sectional view showing a cross section perpendicular to a widthwise direction (R direction) of the toner cartridge 70.

Here, it is assumed that the toner cartridge 70 is projected, onto a first virtual flat plane perpendicular to a first projection direction, in the first projection direction. At this time, the first projection direction in which a projection area on the first virtual flat plane becomes minimum can be called the longitudinal direction of the toner cartridge 70.

Further, as described above, in a state in which the toner cartridge 70 is mounted to the rotary main body 90, the longitudinal direction of the toner cartridge 70 is parallel to the direction (Y direction) of the rotational axis.

Further, it is assumed that a direction perpendicular to the first projection direction is a second direction and the toner cartridge 70 is projected, onto a second virtual flat plane perpendicular to the second projection direction, in the second projection direction. At this time, the second projection direction in which a projection area on the second virtual flat plane becomes minimum can be called the widthwise direction of the toner cartridge 70. That is, the widthwise direction of the toner cartridge 70 is a direction perpendicular to the longitudinal direction of the toner cartridge 70. Further, a direction perpendicular to the longitudinal direction and the widthwise direction of the toner cartridge 70 is called the thickness direction of the toner cartridge 70.

In this embodiment, a longitudinal direction, a widthwise direction, and a thickness direction of the toner frame 71 can be defined by the same method as the method for defining the longitudinal direction, the widthwise direction, and the thickness direction of the toner cartridge 70, respectively. That is, the longitudinal direction, the widthwise direction, and the thickness direction of the toner frame 71 are the same as the longitudinal direction, the widthwise direction, and the thickness direction of the toner cartridge 70, respectively. Accordingly, a length of each of the toner cartridge 70 and the toner frame 71 in the longitudinal direction is longer than a length thereof in the widthwise direction and a length thereof in the thickness direction.

Further, the length of each of the toner cartridge 70 and the toner frame 71 in the widthwise direction is longer than the length thereof in the thickness direction.

In the following description, the longitudinal direction, the widthwise direction, and the thickness direction of the toner frame 71, and the longitudinal direction, the widthwise direction, and the thickness direction of the toner cartridge 70 are not distinguished from each other, and are simply called the longitudinal direction, the widthwise direction, and the thickness direction, respectively. Further, in the following, the longitudinal direction, the widthwise direction, and the toner cartridge direction of the toner cartridge 70 are referred to as the Y direction, the roller direction, and the H direction, respectively. Further, as needed, the Y direction, the R direction, and the H direction illustrated on the drawings are expressed as +Y side, +R side, and +H side, respectively, and opposite sides thereof are expressed as −Y side, −R side, and −H side, respectively.

Further, when the toner cartridge 70 is in the mounted state to the rotary main body 90, description will be made so that with respect to the rotational axis 90C of the rotary main body 90, a rotation radium center side is the −H side and a rotation radius outside is the +H side.

As shown in parts (a) and (b) of FIG. 6, the toner frame 71 of the toner cartridge in this embodiment is provided with the plurality of discharge openings 71b, which include 6 discharge openings consisting of discharge openings 71bL 11, 71bL 12, 71bR 11, 71bR 12, and 71bR 13. Incidentally, one of the discharge openings 71bL 11, 71bL 12, and 71bL 13 is an example of a first discharge opening, and one of the discharge openings 71bR 11, 71bR 12, and 71bR 13 is an example of a second discharge opening disposed in a position different from a position of the first discharge opening.

The discharge openings 71bL 11, 71bL 12, and 71bL 13 are positioned on the −Y side relative to a center (central) portion 71c with respect to the Y direction of the toner frame 71. The discharge openings 71bR 11, 71bR 12, 71bR 13 are positioned on the +Y side relative to the center portion 71c. The plurality of discharge openings 71b communicate with corresponding receiving openings 53b of the developing unit 50, respectively. When the rotary main body 90 takes the above-described supply attitude, the toner accommodated in the toner accommodating portion 71a is discharged through the discharge openings 71bL 11, 71bL 12, 71bL 13, 71bR 11, 71bR 12, and 71bR 13, and are accommodated in the development-side accommodating portion 53a through the corresponding receiving openings 53b.

Further, the toner frame 71 includes the partitioning portion 71p inside the toner accommodating portion 71a. The disposed 71p is provided so as to partition the inside of the toner accommodating portion 71a into a plurality of spaces. The partitioning portion 71p in this embodiment is disposed so as to partition the inside of the toner accommodating portion 71a into a first space SP1 communicating with the discharge openings 71bL 11, 71bL 12, and 71bL 13 and a second space 2 communicating with the discharge openings 71bR 11, 71bR 12, and 71bR 13. The first space SP1 and the second space SP2 are arranged in the Y direction, and the second space SP2 is a space separated from the first space SP1.

In this embodiment, the discharge openings 71bL 11, 71bL 12, and 71bL 13 and the discharge openings 71bR 11, 71bR 12, and 71bR 13 are disposed symmetrically with respect to the Y direction with the center portion 71c as a center, and are disposed with the same size of each opening. For this reason, the partitioning portion 71p is disposed in the neighborhood of the center portion 71c of the toner frame 71 so as to partition the toner accommodating portion 71a into substantially equal (two) sizes. That is, a volume of the first space SP1 and a volume of the second space SP2 are substantially the same. Incidentally, the volume of the first space SP1 and the volume of the second space SP2 do not always have to be the same, but the volume of the first space SP1 may preferably be 80% to 120% of the volume of the second space SP2.

Further, the partitioning portion 71p partitions the toner accommodating portion 71a so that an amount of the toner accommodated in the first space SP1 and an amount of the toner accommodated in the second space SP2 are substantially equal to each other. By this, the amounts of the toner supplied to the development-side accommodating portion 53a through the discharge openings 71bL 11, 71bL 12, and 71bL 13 and through the discharge openings 71bR 11, 71bR 12, and 71bR 13 can made the same.

Incidentally, the amount of the toner accommodated in the first space SP1 and the amount of the toner accommodated in the second space SP2 do not always have to be the same, but the amount of the toner accommodated in the first space SP1 may preferably be 80% to 120% of the amount of the toner accommodated in the second space SP2.

Next, filling of the toner into the toner cartridge 70 will be described using parts (a) and (b) of FIG. 7. Part (a) of FIG. 7 is a sectional view showing the toner cartridge 70 in a state in which a second frame 712 is demounted, and part (b) of FIG. 7 is a sectional view showing a state in which the second frame 712 is mounted to a first frame 711. In parts (a) and (b) of FIG. 7, a state of toner is shown by dots.

The toner frame 71 of the toner cartridge 70 is constituted by the first frame 711 including the partitioning portion 71p and the second frame 712 including the discharge openings 71bL 11, 71bL 12, 71bL 13, 71bR 11, 71bR 12, and 71bR 13. Into the first frame 711, the toner T is filled from an unshown toner filling machine through a nozzle 75. The toner filling machine fills the first frame 711 with the toner T through the nozzle 75 while moving the nozzle in the Y direction. Thereafter, the second frame 712 is bonded to the first frame 711, thus sealing the toner T in the first frame 711. Further, when the nozzle 75 passes through the partitioning portion 71p, it is preferable that the toner T is prevented from being deposited on the partitioning portion 71p by stopping filling-in of the toner T.

### Effect of Embodiment 1

An effect of the embodiment 1 will be described by using the toner cartridge 70 in this embodiment and a toner cartridge 700 as a comparison example 1 in which the partitioning portion 71p is not provided. Part (a) of FIG. 8 is a sectional view showing a cross section, of the toner cartridge 700 according to the comparison example 1, perpendicular to a thickness direction (H direction) of the toner cartridge 700, and part (b) of FIG. 8 is a sectional view showing a cross section of the toner cartridge 700 perpendicular to a widthwise direction (R direction) of the toner cartridge 700. The toner cartridge 700 of the comparison example 1 shown in parts (a) and (b) of FIG. 8 has a shape similar to the shape of the toner cartridge 70 of this embodiment except that the partitioning portion 71p is not provided. That is, the toner cartridge 700 is provided with discharge openings 71bL 11, 71bL 12, 71bL 13, 71bR 11, 71bR 12, and 71bR 13.

In order to demonstrate the effect of this embodiment, comparison and investigation were conducted by using the toner cartridge 70 of this embodiment (embodiment 1) and the toner cartridge 700 of the comparison example 1. In order to reproduce toner localized during transportation, a tapping test described later was conducted, and thereafter a degree of an occurrence of image defect was compared. As the tapping test, as shown in FIG. 9, each of the toner cartridges 70 and 700 was directed downward on the −Y side, and was dropped from a height of 3 mm onto a hard table at a speed of 125 times per minute. After this operation was repeated 100 times, each of the toner cartridges 70 and 700 was mounted to the image forming apparatus 100, and whole blue images (magenta: 100%+cyan: 100%) which were easily visually recognizable for the poor density and the white void were printed on 200 sheets. These images were checked every 50 sheets. Evaluation was made such that the case where the images were good is “O”, the case where the poor density occurred is “A”, and the case where the white void occurred as “x”. A result is shown in a table 1.

TABLE 1

| NOPS*¹ | EMB. 1 | COMP. EX. 1 |
|---|---|---|
| 50 | ◯ | ◯ |
| 100 | ◯ | ◯ |
| 150 | ◯ | Δ |
| 200 | ◯ | X |

*¹“NOPS” is the number of printed sheets (unit: sheets).

States of the toner T in the toner cartridge 70 of this embodiment and the toner T in the toner cartridge 700 of the embodiment 1 when each of the toner cartridges 70 and 700 was mounted to the image forming apparatus 1 after the tapping test are schematically shown in parts (a) and (b) of FIG. 10 and parts (a) and (b) of FIG. 11, respectively.

In either of the toner cartridges 70 and 700, a bulk density of the toner in the toner accommodating portion 71a becomes higher than that during the toner filling by the tapping test. By this, a toner volume occupied in the toner accommodating portion 71a is decreased to about 90% when the toner volume is 100% during the toner filling. In the following, the toner volume during the toner filling is referred to as a toner volume (during filling), and the toner volume after the tapping is referred to as a toner volume (after tapping). That is, the toner volume (after tapping) is 90% of the toner volume (during filling).

In the toner cartridge 700 of the comparison example 1, as shown in part (a) of FIG. 11, the toner in the toner accommodating portion 71a in a state in which the toner is localized (biased) toward the −Y side. That is, the toner amount on the discharge openings 71bL 11, 71bL 12, 71bL 13 side relative to the center portion 71c corresponds to 50% of the toner volume (during filling). On the other hand, the toner amount on the discharge openings 71bR 11, 71bR 12, 71bR 13 side relative to the center portion 71c corresponds to 40% of the toner volume (during filling), and thus becomes smaller than the toner amount on the discharge openings 71bL 11, 71bL 12, 71bL 13 side relative to the center portion 71c.

When the printing progresses and the amount of the toner in the toner accommodating portion 71a, as shown in part (b) of FIG. 11, the toner amount on the discharge openings 71bR 11, 71bR 12, 71bR 13 side decreases, so that the toner supply through the discharge openings 71bR 11, 71bR 12, 71bR 13 becomes insufficient. Due to the insufficient toner supply, as shown in the table 1, when the number of printed sheets is 150 sheets, a part of the image for the discharge openings 71bR 11, 71bR 12, 71bR 13 side caused the poor density, and when the number of printed sheets is 200 sheets, the white void occurred.

On the other hand, for the toner cartridge 70 of this embodiment, the inside of the toner accommodating portion 71a is partitioned by the partitioning portion 71p into the first space SP1 including the discharge openings 71bL 11, 71bL 12, and 71bL 13 and the second space SP2 including the 71bR 11, 71bR 12, and 71bR 13. For that reason, as shown in part (a) of FIG. 10, the toner T in the toner cartridge 70 becomes a state in which the toner is localized by the tapping test toward the −Y side in each of the first space SP1 and the second space SP2 into which the inside of the toner accommodating portion 71a is partitioned by the partitioning portion 71p. However, the inside of the toner accommodating portion 71a is partitioned by the partitioning portion 71p, and therefore, each of the toner volume (after tapping) in the first space SP1 and the toner volume (after tapping) in the second space SP2 corresponds to 45% of the toner volume (during filling). That is, the amount of the toner in the first space SP1 and the amount of the toner in the second space SP2 are equal to each other even after the tapping.

By this, even when the printing progresses and the amount of the toner in the toner accommodating portion 71a is decreased, as shown in part (b) of FIG. 10, the toner supply through the discharge openings 71bL 11, 71bL 12, 71bL 13, 71bR 11, 71bR 12, and 71bR 13 is stabilized. For this reason, in the toner cartridge 70 of the embodiment 1, as shown in the table 1, even when the images were printed on 200 sheets, the image defects such as the poor density and the white void did not occur, so that good images were obtained.

As described above, by providing the partitioning portion 71p inside the toner cartridge 70, even when the toner in the toner accommodating portion 71a is localized due to the transportation or the like, non-uniform toner supply can be alleviated, so that the occurrence of the image defects such as the poor density and the white void can be suppressed.

Incidentally, in this embodiment, the partitioning portion 71p partitions the toner accommodating portion 71a into the first space SP1 and the second space SP2 so as to each including the three discharge openings. That is, the three, as a first number, discharge openings 71bL 11, 71bL 12, and 71bL 13 communicate with the first space SP1. Further, the three, as a second number equal to the first number, discharge openings 71bR 11, 71bR 12, and 71bR 13 communicate with the second space SP2. By this, the toner can be discharged from the first space SP1 and the second space SP2 in good balance.

Incidentally, the first space SP1 and the second space SP2 may be provided so as to communicate with discharge openings different in number from each other. In other words, the partitioning portion 71p may partition the toner accommodating portion 71a into the first space SP1 and the second space SP2 so as to communicate with the discharge openings different in number from each other. Even in such a case, for example, by making sizes of the discharge openings different, a total area of the discharge openings communicating with the first space SP1 and a total area of the discharge openings communicating with the second space SP2 may be made substantially equal to each other.

### Modified Embodiment 1 of Embodiment 1

Next, by using part (a) of FIG. 12, a toner cartridge 70A in a modified embodiment 1 of the embodiment 1 will be described. Part (a) of FIG. 12 is a sectional view showing an inside structure of the toner cartridge 70A in the modified embodiment 1 of the embodiment 1. Incidentally, in the modified embodiment 1, constitutions similar to those in the embodiment 1 will be described by omitting illustration thereof or by adding the same reference numerals or symbols to those in part (a) of FIG. 12.

The toner cartridge 70A of the modified embodiment 1 is different from the toner cartridge 70 of the embodiment 1 in arrangement of a plurality of discharge openings 71b and a plurality of partitioning portions 71p. That is, the toner frame 71 of the toner cartridge 70A of the modified embodiment 1 is provided with the plurality of discharge openings 71b including the three discharge openings 71bL 1, 71bC1, and 71bR1. In the toner cartridge 70A, the number of the discharge openings 71b is made smaller than the number of the discharge openings 71b in the embodiment 1, whereby an area of the discharge openings 71b occupied in the toner frame 71 is decreased and strength of the toner cartridge 70A is increased, so that the toner cartridge 70A is made hard to be deformed.

The discharge opening 71bL is positioned on the −Y side relative to the center portion 71c with respect to the Y direction of the toner frame 71. The discharge opening 71R 1 is positioned on the +Y side relative to the center portion 71c.

Further, the discharge opening 71bC1 is disposed so as to overlap with the center portion 71c. The plurality of discharge openings 71b communicate with corresponding to receiving openings 53b of the developing unit 50, respectively.

Further, the toner frame 71 includes partitioning portions 71pL and 71pR inside the toner accommodating portion 71a. The partitioning portions 71pL and 71pR are provided so as to partition the inside of the toner accommodating portion 71a into a plurality of spaces. The partitioning portions 71pL and 71pR are disposed so as to partition the inside of the toner accommodating portion 71a into a first space SP11 communicating with the discharge opening 71bL1, a second space SP12 communicating with the discharge opening 71bC1, and a third space SP13 communicating with the discharge opening 71bR1.

Also, in this modified embodiment 1, the partitioning portions 71pL and 71pR partition the toner accommodating portion 71a into the first space SP11, the second space SP12, and the third space SP13 so that each of the partitioning portions 71pL and 71pR communicates with at least one discharge opening. Specifically, each of the first space SP11, the second space P12, and the third space SP13 communicates with the same number (one in the modified embodiment 1) of the associated discharge opening(s).

By this, even when the toner in the toner accommodating portion 71a is localized due to the transportation or the like, non-uniform toner supply can be alleviated, so that the occurrence of the image defects such as the poor density and the white void can be suppressed.

### Modified Embodiment 2 of Embodiment 1)

Next, by using part (b) of FIG. 12, a toner cartridge 70B in a modified embodiment 2 of the embodiment 1 will be described. Part (b) of FIG. 12 is a sectional view showing an inside structure of the toner cartridge 70B in the modified embodiment 2 of the embodiment 2. Incidentally, in the modified embodiment 1, constitutions similar to those in the embodiment 1 will be described by omitting illustration thereof or by adding the same reference numerals or symbols to those in part (b) of FIG. 12.

The toner cartridge 70B of the modified embodiment 2 is different from the toner cartridge 70 of the embodiment 1 in number and arrangement of a plurality of partitioning portions 71p. That is, the toner frame 71 of the toner cartridge 70B of the modified embodiment 2 includes five partitioning portions 71p11, 71p12, 71p13, 71p14, and 71p15 inside the toner accommodating portion 71a. The partitioning portions 71p11, 71p12, 71p13, 71p14, and 71p15 are provided so as to partition the inside of the toner accommodating portion 71a onto a plurality of spaces. The partitioning portions 71p11, 71p12, 71p13, 71p14, and 71p15 are disposed so as to partition the inside of the toner accommodating portion 71a into a first space SP21 communicating with a discharge opening 71bL11, a second space SP22 communicating with a discharge opening 71bL12, a third space SP23 communicating with a discharge opening 71bL 13, a fourth space SP24 communicating with a discharge opening 71bR13, a fifth space SP25 communicating with a discharge opening 71bR12, and a sixth space SP26 communicating with a discharge opening 71bR11.

Also, in this modified embodiment 2, the partitioning portions 71p11, 71p12, 71p13, 71p14, and 71p15 partition the accommodating portion 71a into the first space SP21, the second space SP22, the third space SP23, the fourth space SP24, the fifth space SP25, and the sixth space SP26 so that each of the partitioning portions 71p11 to 71p15 communicates with at least one discharge opening. Specifically, each of the first space SP21, the second space SP22, the third space SP23, the fourth space SP24, the fifth space SP25, and the sixth space SP26 communicates with the same number (one in the modified embodiment 1) of the associated discharge opening(s).

By this, even when the toner in the toner accommodating portion 71a is localized due to the transportation or the like, non-uniform toner supply can be alleviated, so that the occurrence of the image defects such as the poor density and the white void can be suppressed.

Further, in the toner cartridge 70B of the modified embodiment 2, the number of the partitioning portions is made larger than the number of the partitioning portion in the embodiment 1, and thus an inside space of the toner accommodating portion 71a is partitioned into more spaces than in the embodiment 1, so that the influence on the localization of the toner can be made small.

On other hand, as in the above-described modified embodiments 1 and 2, by increasing the number of partitioning portions for partitioning the toner accommodating portion 71a, a space, other than the partitioning portions, occupied in the toner accommodating portion 71a is decreased, and therefore, the amount of the toner capable of being filled in the toner cartridge is decreased. Due to a balance between a size of the toner cartridge and a necessary toner amount in the image forming apparatus 1, an optimum number of partitioning portions may desirably be selected appropriately.

### Embodiment 2

Next, a toner cartridge 70C according to an embodiment 2 will be described, but in the embodiment 2, the number and the arrangement of the discharge openings 71b in the embodiment 1 are changed. For this reason, constitutions similar to those in the embodiment 1 will be described by omitting illustration thereof or by adding the same reference numerals or symbols to those in parts (a) and (b) of FIG. 13. Part (a) of FIG. 13 is a sectional view showing the toner cartridge 70C of the embodiment 2, and part (b) of FIG. 13 is a sectional view showing a positional relationship between the toner cartridge 70C and the scanner 4.

As shown in part (a) of FIG. 13, inside the toner cartridge 70C, the partitioning portion 71p is provided similarly as in the embodiment 1. The partitioning portion 71p is disposed in the center portion 71c with respect to the Y direction of the toner frame 71, and partitions the toner accommodating portion 71a into the first space SP1 and the second space SP2.

Further, the toner frame 71 of the toner cartridge 70C of this embodiment is provided with a plurality of discharge openings 71b including two discharge openings 71bL and 71bR. The discharge opening 71bL as a first discharge opening communicates with the first space SP1 and is disposed in an end portion on the −Y side. The discharge opening 71bR as a second discharge opening communicates with the second space SP2 and is disposed in an end portion on the +Y side. That is, the discharge openings 71bL and 71bR are disposed in one end portion and the other end portion, respectively, of the toner frame 71 with respect to the Y direction of the toner frame 71. The discharge openings 71bL and 71bR communicate with corresponding receiving openings 53b, respectively, of the developing unit 50.

Incidentally, in the embodiment 1, the plurality of discharge openings 71b were also disposed on the center portion 71c side with respect to the Y direction of the toner cartridge 70. As described above, the toner cartridge 70 is movable to the mounting position and the retracted position relative to the developing frame 53 of the developing unit 50. In the case where the toner cartridge 70 is in the mounting position to the developing frame 53, the discharge openings 71b oppose the receiving opening of the developing unit 50. At this time, the discharge openings 71b are sealed by unshown sealing members so as to prevent the toner from leaking out to an outside of the receiving openings 53b of the developing unit 50.

Further, also in the case where the toner cartridge 70 is in the retracted position from the developing frame 53, similarly, the discharge openings 71b are sealed by the unshown sealing members so as to prevent the toner from leaking out to the outside of the receiving openings 53b of the developing unit 50. However, by an exchanging operation of the toner cartridge 70 and a rotating operation of the rotary main body 90, there is a possibility that the toner slightly leaks out of the discharge openings 71b.

An amount of such toner is small, and therefore is not problematic ordinarily, but in the case where a lifetime of the image forming apparatus 1 is prolonged, when exchange of the toner cartridge 70 is repeated, the toner leaked out through the discharge openings 71b is accumulated in a downward direction (−Z direction) of the gravitational direction relative to the discharge openings 71b. In the image forming apparatus 1 as shown in FIG. 1, the scanner 4 is disposed relative to the toner cartridge 70 on −Z (axis) direction side, i.e., on a lower side with respect to the gravitational direction. For this reason, when the image forming operation is repeated and the number of printed sheets is increased, the toner leaked out from the toner cartridge 70 is accumulated on the scanner 4, so that the scanner 4 was contaminated with the toner in some instances. In the image forming apparatus intended to prolong a lifetime thereof, in order to prevent contamination of the scanner 4, there is a need to take countermeasure such that a cover glass is placed on an opening of the scanner 4 and a cleaning member when the cover glass is contaminated with the toner accumulated thereon is provided, or the like countermeasure. This causes increases in cost and a size of the image forming apparatus 1 due to complication of a mechanism.

Part (a) of FIG. 14 is a sectional view showing a toner cartridge 700B according to a comparison example 2, and part (b) of FIG. 14 is a sectional view showing a positional relationship between the toner cartridge 700B and the scanner 4. As shown in parts (a) and (b) of FIG. 14, in the toner cartridge 700B of the comparison example 2, similarly as in the embodiment 2, the discharge opening 71bL is disposed in the end portion of the toner frame 71 on the −Y side, and the discharge opening 71bR is disposed in the end portion of the toner frame 71 on the +Y side. Further, these discharge openings 71bL and 71bR are disposed so as not to overlap with the scanner 4 with respect to the Y direction. That is, with respect to the Y direction, positions (ranges in which the discharge openings 71bL and 71bR are present) of the discharge openings 71bL and 71bR do not overlap with a position (range in which the scanner 4 is present) of the scanner 4. In other words, in the case where the discharge openings 71bL and 71bR and the scanner 4 are projected in a direction perpendicular to the Y direction, projection regions of the discharge openings 71bL and 71bR and a projection region of the scanner 4 do not overlap with each other with respect to the Y direction.

By such a constitution of the comparison example 2, contamination of the scanner 4 with the toner can be suppressed.

However, when the discharge openings 71bL and 71bR are provided in opposite end portions of the toner accommodating portion 71a with respect to the Y direction, the toner positioned away from the discharge openings 71bL and 71bR becomes hard to be discharged. Particularly, in a state in which the toner inside the toner cartridge 700B is localized with respect to the Y direction due to the transportation or the like, compared with the case where the discharge openings 71b are disposed over a whole area with respect to the Y direction, amounts of the toner passing through the plurality of discharge openings 71b are liable to cause a difference therebetween, so that supply of the toner toward the developing unit 50 becomes non-uniform. By this, there is a liability that image defects such as the poor density such that an image density becomes poor in a part of an image region and the white void such that a part of the image is not printed occur.

In order to solve such a problem, in this embodiment, as shown in parts (a) and (b) of FIG. 13, the partitioning portion 71p is provided inside the toner cartridge 70C. By this, even in the case where the discharge openings 71bL and 71bR are disposed in opposite end portions of the toner accommodating portion 71a with respect to the Y direction, the localization of the toner in the first space SP1 and the second space SP2 can be suppressed. Therefore, even when the toner in the toner cartridge 70C is localized by the transportation or the like, non-uniform toner supply through the plurality of discharge openings 71bL and 71bR is alleviated, so that the occurrence of the image defects such as the poor density and the white void can be suppressed. Incidentally, a positional relationship between the discharge openings 71bL and 71bR and the scanner 4 is similar to that in the comparison example 2 shown in part (b) of FIG. 14. That is, as shown in part (b) of FIG. 3, the discharge openings 71bL and 71bR in the embodiment 2 are disposed so as not to overlap with the scanner 4 with respect to the Y direction.

The partitioning portion 71p is provided in the center portion 71c of the toner frame 71 with respect to the Y direction, and parts the toner accommodating portion 71a into the first space SP1 and the second space SP2 similarly as in the embodiment 1. In this embodiment, the discharge openings 71bL and 71bR are disposed symmetrically with respect to the longitudinal direction (Y direction) with the center portion 71c as a center, and are disposed with the same size of each opening. That is, the partitioning portion 71p partitions the toner accommodating portion 71a so that, a volume of the first space SP1 and a volume of the second space SP2 are substantially the same and so that an amount of the toner accommodated in the first space SP1 and an amount of the toner accommodated in the second space SP2 are substantially equal to each other. By this, the amounts of the toner supplied to the development-side accommodating portion 53a through the discharge opening 71bL and through the discharge opening 71bR can made the same.

### Effect of Embodiment 2

An effect of the embodiment 2 will be described by using the toner cartridge 70C in this embodiment and a toner cartridge 700B as a comparison example 2 in which the partitioning portion 71p is not provided. The toner cartridge 700B of the comparison example 2 shown in parts (a) and (b) of FIG. 14 has a shape similar to the shape of the toner cartridge 70C of the embodiment 2 except that the partitioning portion 71p is not provided.

In order to demonstrate the effect of this embodiment, comparison and investigation were conducted by using the toner cartridge 70C of this embodiment (embodiment 2) and the toner cartridge 700B of the comparison example 2. In order to reproduce toner localized during transportation, a tapping test described later was conducted, and thereafter a degree of an occurrence of image defect was compared. As the tapping test, as shown in FIG. 9, each of the toner cartridges 70C and 700B was directed downward on the −Y side, and was dropped from a height of 3 mm onto a hard table at a speed of 125 times per minute. After this operation was repeated 100 times, each of the toner cartridges 70C and 700B was mounted to the image forming apparatus 100, and whole blue images (magenta: 100%+cyan: 100%) which were easily visually recognizable for the poor density and the white void were printed on 200 sheets. These images were checked every 50 sheets. Evaluation was made such that the case where the images were good is “O”, the case where the poor density occurred is “A”, and the case where the white void occurred as “x”. A result is shown in a table 2.

TABLE 2

| NOPS*¹ | EMB. 2 | COMP. EX. 2 |
|---|---|---|
| 50 | ◯ | ◯ |
| 100 | ◯ | Δ |
| 150 | ◯ | X |
| 200 | ◯ | X |

*¹“NOPS” is the number of printed sheets (unit: sheets).

States of the toner T in the toner cartridge 70C of this embodiment and the toner T in the toner cartridge 700B of the embodiment 2 when each of the toner cartridges 70C and 700B was mounted to the image forming apparatus 1 after the tapping test are schematically shown in parts (a) and (b) of FIG. 15 and parts (a) and (b) of FIG. 16, respectively.

In either of the toner cartridges 70C and 700B, a bulk density of the toner in the toner accommodating portion 71a becomes higher than that during the toner filling by the tapping test. By this, a toner volume occupied in the toner accommodating portion 71a is decreased to about 90% when the toner volume is 100% during the toner filling.

In the toner cartridge 700B of the comparison example 2, as shown in part (a) of FIG. 16, the toner in the toner accommodating portion 71a in a state in which the toner is localized (biased) toward the −Y side. That is, the toner amount on the discharge opening 71bL side relative to the center portion 71c corresponds to 50% of the toner volume (during filling). On the other hand, the toner amount on the discharge opening 71bR side relative to the center portion 71c corresponds to 40% of the toner volume (during filling), and thus becomes smaller than the toner amount on the discharge opening 71bL side relative to the center portion 71i c.

When the printing progresses and the amount of the toner in the toner accommodating portion 71a, as shown in part (b) of FIG. 16, the toner amount on the discharge opening 71bR side decreases, so that the toner supply through the discharge opening 71bR becomes insufficient. Due to the insufficient toner supply, as shown in the table 2, when the number of printed sheets is 100 sheets, a part of the image for the discharge opening 71bR side caused the poor density, and when the number of printed sheets is 150 sheets and 200 sheets, the white void occurred.

On the other hand, for the toner cartridge 70C of the embodiment 2, the inside of the toner accommodating portion 71a is partitioned by the partitioning portion 71p into the first space SP1 including the discharge opening 71bL and the second space SP2 including the 71bR. For that reason, as shown in part (a) of FIG. 15, the toner T in the toner cartridge 70 becomes a state in which the toner is localized by the tapping test toward the −Y side in each of the first space SP1 and the second space SP2 into which the inside of the toner accommodating portion 71a is partitioned by the partitioning portion 71p. However, the inside of the toner accommodating portion 71a is partitioned by the partitioning portion 71p, and therefore, each of the toner volume (after tapping) in the first space SP1 and the toner volume (after tapping) in the second space SP2 corresponds to 45% of the toner volume (during filling). That is, the amount of the toner in the first space SP1 and the amount of the toner in the second space SP2 are equal to each other even after the tapping.

By this, even when the printing progresses and the amount of the toner in the toner accommodating portion 71a is decreased, as shown in part (b) of FIG. 15, the toner supply through the discharge openings 71bL and 71bR is stabilized.

For this reason, in the toner cartridge 70C of the embodiment 2, as shown in the table 2, even when the images were printed on 200 sheets, the image defects such as the poor density and the white void did not occur, so that good images were obtained.

As described above, by providing the discharge openings 71bL and 71bR in opposite end portions of the toner accommodating portion 71a with respect to the Y direction so that the discharge openings 71bL and 71bR do not overlap with the scanner 4 with respect to the Y direction, so that it is possible to suppress that the scanner 4 is contaminated with the toner.

Further, by providing the partitioning portion 71p inside the toner cartridge 70C, even when the toner in the toner accommodating portion 71a is localized due to the transportation or the like, amounts of the toner in the first space SP1 and the second space SP2 can be made substantially equal to each other. Further, even when the discharge openings 71bL and 71bR are disposed in the opposite end portions of the toner accommodating portions with respect to the Y direction, non-uniform toner supply through the discharge openings 71bL and 71bR can be alleviated, so that the occurrence of the image defects such as the poor density and the white void can be suppressed.

### Embodiment 3

Next, a toner cartridge 70D according to an embodiment 3 will be described, but the embodiment 3 is constituted by providing a plurality of guiding portions 71g in the first space SP1 and the second space SP2 in the embodiment 2. For this reason, constitutions similar to those in the embodiment 1 will be described by omitting illustration thereof or by adding the same reference numerals or symbols to those in parts (a) and (b) of FIG. 17. Part (a) of FIG. 17 is a sectional view showing a cross section of the toner cartridge 70D perpendicular to a thickness direction (H direction) of the toner cartridge 70D of the embodiment 3, and part (b) of FIG. 17 is a sectional view showing a cross section of the toner cartridge 70D perpendicular to a widthwise direction (R direction) of the toner cartridge 70D.

As shown in part (a) of FIG. 17, the toner cartridge 70D of this embodiment includes a toner frame 71 constituted by a first frame 711 and a second frame 712. The first frame 711 is provided with the partitioning portion 71p similarly as in the embodiment 1. The partitioning portion 71p partitions the toner accommodating portion 71a into the first space SP1 and the second space SP2 by boding the second frame 712 to the first frame 711. The partitioning portion 71p is disposed in the center portion 71c with respect to the Y direction of the toner frame 71.

Further, the toner frame 71 of the toner cartridge 70D of this embodiment is provided with two discharge openings 71bL and 71bR. The discharge opening 71bL communicates with the first space SP1 and is disposed in an end portion on the −Y side. The discharge opening 71bR communicates with the second space SP2 and is disposed in an end portion on the +Y side. The discharge openings 71bL and 71bR communicate with corresponding receiving openings 53b, respectively, of the developing unit 50.

Further, the second frame 712 of the toner frame 71 includes, as shown in parts (a) and (b) of FIG. 17, the plurality of guiding portions 71g for guiding the toner accommodated in the toner accommodating portion 71a. In this embodiment, the plurality of guiding portions 71g include a plurality of left-side guides 71gL as a first guiding portion and a plurality of right-side guides 71gR. The left-side guides 71gL extend in −Y direction toward −R direction, and the right-side guides 71gR extend in +Y direction toward the −R direction. That is, the left-side guides 71gL and the right-side guides 71gR extend so as to be inclined with respect to the R direction and the Y direction.

The left-side guides 71gL are disposed between the partitioning portion 71p (or the center portion 71c) and the discharge opening 71bL with respect to the Y direction and are disposed with gaps with inner walls of the toner frame 71 with respect to the R direction. The right-side guides 71gR are disposed between the partitioning portion 71p (or the center portion 71c) and the discharge opening 71bR with respect to the Y direction and are disposed with gaps with the inner walls of the toner frame 71 with respect to the R direction. Further, the left-side guides 71gL and the right-side guides 71gR are disposed with a gap with an inner wall of the toner frame 71 with respect to the H direction, and may preferably be disposed with a gap which is about half of a distance between the frames 711 and 712.

The left-side guides 71gL guide the toner moved by self-weight toward the discharge opening 71bL provided on the −Y side with rotation of the rotary main body 90 described later. The right-side guides 71gR guide the toner moved by self-weight toward the discharge opening 71bR provided on the +Y side with the rotation of the rotary main body 90. The left-side guides 71gL and the discharge opening 71bL has a symmetrical shape with the right-side guides 71gR and the discharge opening 70bR with respect to the Y direction, but the symmetrical shape is not necessarily required to be a completely symmetrical shape. Further, the number of the left-side guides 71gL and the number of the right-side guides 71gR may be different from each other.

### (Guiding of Toner Toward Discharge Openings by Guiding Portions)

By using FIG. 20 and parts (a) and (b) of FIG. 21, movement of the toner with the rotation of the rotary main body 90 will be described. FIG. 20 is a schematic view, as viewed in the Y direction, showing the toner cartridge 70D rotated about the rotational axis 90C. Parts (a) and (b) of FIG. 21 are schematic views showing an inside structure of the toner cartridge 70D with respect to the longitudinal direction (Y direction) in positions Tp3 and Tp7, respectively, in FIG. 20.

In FIG. 20, the rotary main body 90 is rotated in a clockwise direction (arrow R2 direction). In the case where the toner cartridge 70D is rotated once (one full turn) from a position Tp0, the toner cartridge 70D is moved in an order of positions Tp0, Tp1, Tp2, Tp3m Tp4, Tp5, Tp6 and Tp7, and then is returned to the position Tp0.

The rotary main body 90 takes the above-described exchange attitude when the toner cartridge 70D in the position Tp2 is exchanged. The toner cartridge 70D in the position Tp2 is mounted to and demounted from the rotary main body 90. When the toner cartridge 70D is rotated from the position Tp2 to the position Tp4, by gravitation acting on the toner, the toner in the toner cartridge 70D is moved along the frame 711. For example, when the toner cartridge 70D is in the position Tp3, as shown in part (a) of FIG. 21, the toner is moved in the toner accommodating portion 71a. With respect to the H direction, between the frame 711 and the plurality of guiding portions 71g, the gap is formed, and therefore, most of the toner in the toner accommodating portion 71a is not influenced by the guiding portions 71g, so that the toner is moved only in the +R direction indicated as an arrow G1, and is not moved in the Y direction.

Further, when the toner cartridge 70D is rotated from the position Tp6 to the position Tp0, by the gravitation acting on the toner, the toner in the toner cartridge 70D is moved along the frame 712. For example, when the toner cartridge 70D is in the position Tp7, as shown in part (b) of FIG. 21, the toner is moved in the toner accommodating portion 71a. The frame 712 is provided with the plurality of guiding portions 71g, and therefore, the toner is moved along the guiding portions 71g in-R direction and the ±Y directions as indicated by arrows G2. Further, with respect to the R direction, there is a gap between the frame 711 and the guiding portions 71g, and therefore, the toner moved along the guiding portions 71g in the R direction can be moved toward the discharge openings 71b (71bL, 71bR) in the +Y directions as indicated by arrows G3.

By repeating the above-described operation, the toner in the toner accommodating portion 71a is guided toward the discharge openings 71bL and 71bR by the guiding portions 71g. Thus, by utilizing the rotation of the rotary main body 90, without using a stirring member, the toner positioned away from the discharge openings 71bL and 71bR can also be efficiently supplied to the development-side accommodating portion 53a.

Here, in a state in which the toner accommodated in the accommodating portion 71a is left standing for a long term in a high-temperature/high-humidity environment after unshown sealing members are removed from the discharge openings 70bL and 70bR, toner flowability is deteriorated. In such a toner state, there is a liability that the toner positioned away from the discharge openings 71bL and 71bR becomes hard to be discharged, and thus the toner remains in the toner accommodating portion 71a. However, in the toner cartridge 70D of this embodiment, the plurality of guiding portions 71g is provided and the toner in the toner accommodating portions 71a is guided toward the discharge openings 71bL and 71bR with the rotation of the rotary main body 90, so that a toner discharging property is improved.

Next, filling of the toner into the toner cartridge 70D will be described using parts (c) and (d) of FIG. 19. Part (a) of FIG. 19 is a sectional view showing the toner cartridge 70D in a state in which the second frame 712 is demounted, and part (b) of FIG. 19 is a sectional view showing a state in which the second frame 712 is mounted to the first frame 711. In parts (a) and (b) of FIG. 19, a state of the toner T is shown by dots.

The toner frame 71 of the toner cartridge 70D is constituted by the first frame 711 including the partitioning portion 71p and the second frame 712 including the discharge openings 71bL and 71bR and the plurality of guiding portions 71g. Into the first frame 711, the toner T is filled through a nozzle 75 from an unshown toner filling machine. The nozzle 75 fills toner in a predetermined amount while moving in the Y direction. Thereafter, the second frame 712 is bonded to the first frame 711, so that the toner T is sealed. Further, when the nozzle 75 passes through the partitioning portion 71p, it is preferable that the toner T is prevented from being deposited on the partitioning portion 71p by stopping flowing-in of the toner T.

### Effect of Embodiment 3

An effect of the embodiment 3 will be described by using the toner cartridge 70D in this embodiment and a toner cartridge 700C as a comparison example 3 in which the partitioning portion 71p is not provided. The toner cartridge 700C of the comparison example 3 shown in parts (a) and (b) of FIG. 18 has a shape similar to the shape of the toner cartridge 70D of the embodiment 3 except that the partitioning portion 71p is not provided.

In order to demonstrate the effect of this embodiment, comparison and investigation were conducted by using the toner cartridge 70D of this embodiment (embodiment 3), the toner cartridge 700B of the comparison example 2 and the toner cartridge 700C of the comparison example 3. In order to reproduce toner localized during transportation, a tapping test described later was conducted, and thereafter a degree of an occurrence of image defect was compared. As the tapping test, as shown in FIG. 9, each of the toner cartridges 70D and 700C was directed downward on the −Y side, and was dropped from a height of 3 mm onto a hard table at a speed of 125 times per minute. After this operation was repeated 100 times, each of the toner cartridges 70D and 700C was mounted to the image forming apparatus 100, and whole blue images (magenta: 100%+cyan: 100%) which were easily visually recognizable for the poor density and the white void were printed on 200 sheets. These images were checked every 50 sheets. Evaluation was made such that the case where the images were good is “O”, the case where the poor density occurred is “A”, and the case where the white void occurred as “x”. A result is shown in a table 3.

TABLE 3

| NOPS*¹ | EMB. 3 | COMP. EX. 2 | COMP. EX. 3 |
|---|---|---|---|
| 50 | ◯ | ◯ | ◯ |
| 100 | ◯ | Δ | ◯ |
| 150 | ◯ | X | ◯ |
| 200 | ◯ | X | Δ |

*¹“NOPS” is the number of printed sheets (unit: sheets).

States of the toner T in the toner cartridge 70D of this embodiment, the toner T in the toner cartridge 700B of the comparison example 2, and the toner T in the toner cartridge 700D of the embodiment 3 when each of the toner cartridges 70D and 700C was mounted to the image forming apparatus 1 after the tapping test are schematically shown in parts (a) and (b) of FIG. 22, parts (a) and (b) of FIG. 16, and parts (a) and (b) of FIG. 23, respectively.

In either of the toner cartridges 70D, 700B, and 700C, a bulk density of the toner in the toner accommodating portion 71a becomes higher than that during the toner filling by the tapping test. By this, a toner volume occupied in the toner accommodating portion 71a is decreased to about 90% when the toner volume is 100% during the toner filling.

In the toner cartridge 700B of the comparison example 2, and in the toner cartridge 700C of the comparison example 3, as shown in part (a) of FIG. 16 and part (a) of FIG. 23, the toner in the toner accommodating portion 71a in a state in which the toner is localized (biased) toward the −Y side. That is, the toner amount on the discharge opening 71bL side relative to the center portion 71c corresponds to 50% of the toner volume (during filling). On the other hand, the toner amount on the discharge opening 71bR side relative to the center portion 71c corresponds to 40% of the toner volume (during filling), and thus becomes smaller than the toner amount on the discharge opening 71bL side relative to the center portion 71c.

In the comparison example 2, when the printing progresses and the amount of the toner in the toner accommodating portion 71a, as shown in part (b) of FIG. 16, the toner amount on the discharge opening 71bR side decreases, so that the toner supply through the discharge opening 71bR becomes insufficient. Due to the insufficient toner supply, as shown in the table 3, when the number of printed sheets is 100 sheets, a part of the image for the discharge opening 71bR side caused the poor density, and when the number of printed sheets is 150 sheets and 200 sheets, the white void occurred.

Further, in the comparison example 3, the plurality of guiding portions 71g are provided in the toner accommodating portion 71a. For that reason, the toner in the toner accommodating portion 71a can be guided toward the discharge openings 71bL and 71bR with the rotation of the rotary main body 90. For this reason, compared with the comparison example 2, the image defects are not readily caused to occur, but when the number of printed sheets is 200 sheets, the poor density occurred in a part of the image on a side corresponding to the discharge opening 71bR side.

On the other hand, for the toner cartridge 70D of the embodiment 3, the inside of the toner accommodating portion 71a is partitioned by the partitioning portion 71p into the first space SP1 including the discharge opening 71bL and the second space SP2 including the 71bR. Further, in the toner accommodating portion 71a of the toner cartridge 70D, the plurality of guiding portions 71g are provided. For that reason, as shown in part (a) of FIG. 22, the toner T in the toner cartridge 70 becomes a state in which the toner is localized by the tapping test toward the −Y side in each of the first space SP1 and the second space SP2 into which the inside of the toner accommodating portion 71a is partitioned by the partitioning portion 71p. However, the inside of the toner accommodating portion 71a is partitioned by the partitioning portion 71p, and therefore, each of the toner volume (after tapping) in the first space SP1 and the toner volume (after tapping) in the second space SP2 corresponds to 45% of the toner volume (during filling). That is, the amount of the toner in the first space SP1 and the amount of the toner in the second space SP2 are equal to each other even after the tapping. Further, by the plurality of guiding portions 71g, the toner in the toner accommodating portion 71a can be guided toward the discharge openings 71bL and 71bR with the rotation of the rotary main body 90.

By this, even when the printing progresses and the amount of the toner in the toner accommodating portion 71a is decreased, as shown in part (b) of FIG. 22, the toner supply through the discharge openings 71bL and 71bR is stabilized. For this reason, in the toner cartridge 70D of the embodiment 3, as shown in the table 3, even when the images were printed on 200 sheets, the image defects such as the poor density and the white void did not occur, so that good images were obtained.

As described above, by providing the partitioning portion 71p inside the toner cartridge 70C, even in a state in which the toner in the toner accommodating portion 71a is localized due to the transportation or the like and in which the toner flowability becomes worse, amounts of the toner in the first space SP1 and the second space SP2 can be made substantially equal to each other. Further, even when the discharge openings 71bL and 71bR are disposed in the opposite end portions of the toner accommodating portions with respect to the Y direction, non-uniform toner supply through the discharge openings 71bL and 71bR can be alleviated, so that the occurrence of the image defects such as the poor density and the white void can be suppressed.

Incidentally, the plurality of guiding portions 71g in this embodiment is provided on the second frame 712, but the present invention is not limited thereto. The guiding portions 71g may be provided on the first frame 711. In this case, the guiding portions 71g may be disposed not only on an inner wall of an end portion of the first frame 711 with respect to the H direction but also on an inner wall of an end portion of the first frame 711 with respect to the R direction.

Further, the guiding portions may be provided on both of the first frame 711 and the second frame 712. In either case, the guiding portions may only be required to be constituted so that the toner moved by the weight thereof is guided toward the discharge openings 71b (71bL, 71bR) with the rotation of the rotary main body 90.

### Modified Embodiment of Embodiment 3

In the above-described embodiment 3, the partitioning portion 71p is formed in a rectangular shape in cross section as viewed in the R direction, but the present invention is not limited thereto. For example, as shown in parts (a) and (b) of FIG. 24, the disposed 71p may be formed so as to include inclined surfaces 71q1 and 71q2. The inclined surface 71q1 as a first guiding surface is disposed on the first space SP1 side, and the inclined surface 71q2 as a second guiding surface is disposed on the second space SP2 side.

Each of the inclined surfaces 71q1 and 71q2 has an inclination angle similar to an inclination angle of an associated one of the left-side guides 71gL and the right-side guides 71gR, respectively. The inclined surface 71q1 extends in the −Y direction toward the −R direction, and the inclined surface 71q2 extends in the +Y direction toward the −R direction. That is, the inclined surfaces 71q1 and 71q2 extend so as to be inclined with respect to the R direction and the Y direction.

By this, the inclined surfaces 71q1 and 71q2 have a function similar to the function of the guiding portions 71g, and are capable of efficiently guide the toner, moved by the weight thereof, toward the discharge openings 71b (71bL, 71bR).

### Other Embodiments

Further, in either one of the above-described embodiments, as an example of the image forming apparatus 1, the image forming apparatus of a rotary development type was described, but the present invention is not limited thereto. That is, when the image forming apparatus is an image forming apparatus using a toner exchange type in which the toner cartridge is exchanged, by using the toner cartridge in the present invention, a similar effect can be obtained.

Further, in either one of the above-described embodiments, sizes of the plurality of discharge openings 71b are the same, and therefore, sizes of the division spaces by the partitioning portion and the number of the discharge openings 71b communicating with these spaces are made similar to each other, but the present invention is not limited thereto. Depending on the size of the discharge openings 71b and arrangement of the discharge openings 71b with respect to the Y direction, a plurality of division spaces by the partitioning portion 71p may be different from each other in size. Further, the plurality of spaces may only be required to be partitioned so as to each include at least one of the plurality of discharge openings 71b.

Further, in either one of the above-described embodiments, a single partitioning portion (71p) has a function of partitioning a single space into two spaces, but the present invention is not limited thereto. For example, by forming the partitioning portion in a V-shape in cross section, a constitution in which the single space is partitioned into three spaces by the single partitioning portion may be employed. Thus, the number of partitioned spaces by the single partitioning portion is not limited.

According to the present invention, the image defects can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074990 filed on May 2, 2024, which is hereby incorporated by reference herein in its entirety.

What is claimed is:

1. An image forming apparatus comprising:
a main assembly including a photosensitive drum, a developing unit including a developing roller, and a rotary rotatably supporting the developing unit; and
a toner cartridge detachably mountable to the developing unit, the toner cartridge including
a frame extending in a longitudinal direction and including an accommodating chamber for accommodating toner, a first discharge opening through with the toner discharged from the accommodating chamber to the developing unit passes, and a second discharge opening through which the toner discharged from the accommodating chamber to the developing unit passes, wherein the second discharge opening is provided in a position different in position from the first discharge opening with respect to the longitudinal direction, and
a partitioning portion configured to partition the accommodating chamber into a plurality of spaces including a first space and a second space separated from the first space,
wherein the first discharge opening communicates with the first space, and
the second discharge opening communicates with the second space.

2. An image forming apparatus according to claim 1, wherein the first space and the second space are arranged in the longitudinal direction.

3. An image forming apparatus according to claim 2, wherein the first discharge opening is provided in one end portion of the frame with respect to the longitudinal direction, and the second discharge opening is provided in the other end portion of the frame with respect to the longitudinal direction.

4. An image forming apparatus according to claim 2, wherein the partitioning portion is provided in a central portion of the frame with respect to the longitudinal direction.

5. An image forming apparatus according to claim 1, wherein the toner cartridge includes
a first guiding portion provided in the first space and for guiding the toner, toward the first discharge opening, accommodated in the first space and moved by a self-weight thereof, and
a second guiding portion provided in the second space and for guiding the toner, toward the second discharge opening, accommodated in the second space and moved by the self-weight thereof.

6. An image forming apparatus according to claim 5, wherein each of the first guiding portion and the second guiding portion are provided so as to be inclined with respect to the longitudinal direction.

7. An image forming apparatus according to claim 1, wherein the partitioning portion is provided with a first guiding surface for guiding the toner, toward the first discharge opening, accommodated in the first space and moved by a self-weight thereof, and a second guiding surface for guiding the toner, toward the second discharge opening, accommodated in the second space and moved by the self-weight thereof.

8. An image forming apparatus according to claim 1, wherein an amount of the toner accommodated in the first space is 80% to 120% of an amount of the toner accommodated in the second space.

9. An image forming apparatus according to claim 1, wherein a volume of the first space is 80% to 120% of a volume of the second space.

10. An image forming apparatus according to claim 1, wherein the main assembly includes an exposure device for forming an electrostatic latent image on a surface of the photosensitive drum by exposing the surface of the photosensitive drum to light, and
wherein in a state in which the toner cartridge is mounted to the developing unit, the first discharge opening and the second discharge opening are provided so as to non-overlap with the developing unit with respect to the longitudinal direction.

11. An image forming apparatus according to claim 1, wherein a rotational axis of the rotary extends in the longitudinal direction.
